(19) United States
(12) Patent Application Publication
(10) Pub. No.: US 2026/0260616 A1
(43) Pub. Date: Sep. 3, 2026

(54) PIXEL CIRCUIT AND DRIVING METHOD THEREOF, AND A DISPLAY PANEL

(71) Applicant: Beijing Visionox Technology Co., Ltd., Beijing (CN)

(72) Inventors: Cuili GAI, Beijing (CN); Enqing GUO, Beijing (CN)

(73) Assignee: Beijing Visionox Technology Co., Ltd., Beijing (CN)

(21) Appl. No.: 19/654,471

(22) Filed: Apr. 22, 2026

(30) Foreign Application Priority Data
Apr. 30, 2025 (CN) 202510571450.4

(51) Int. Cl. G09G 3/3233

(52) U.S. Cl. CPC G09G 3/3233; G09G 2300/043; G09G 2300/0465; G09G 2300/0819; G09G 2300/0842; G09G 2310/0245; G09G 2310/08; G09G 2320/0233; G09G 2320/0247; G09G 2320/045; G09G 2330/023

(57) ABSTRACT

The present application discloses a pixel circuit and a driving method thereof, and a display panel. The pixel circuit includes: a driving module, a coupling module and a data writing module, and a first terminal of the coupling module is connected to a control terminal of the driving module; a first terminal of the data writing module is connected to a first terminal of the driving module, the first terminal of the data writing module is further connected to a second terminal of the coupling module, the data writing module is configured to transmit a data voltage to the second terminal of the coupling module, and the coupling module is configured to couple a voltage containing data voltage information at the second terminal of the coupling module to the control terminal of the driving module. The embodiments of the present application improves the usage performance of the display panel.

### CROSS-REFERENCE TO RELATED APPLICATIONS

This application claims priority to Chinese Patent Application No. 202510571450.4, filed on April 30, 2025, entitled "pixel circuit and driving method thereof, and a display panel", which is incorporated herein by reference in its entirety.

### FIELD

The present application relates to the field of display technology, and particularly relates to a pixel circuit and a driving method thereof, and a display panel.

### BACKGROUND

With the rapid development of display technology, display products formed by organic light-emitting diodes (OLEDs) or light-emitting diodes (LEDs) have been increasingly widely applied.

A display product includes a display panel, and an existing display panel has a problem of usage performance that needs to be improved.

### SUMMARY

The present disclosure provides a pixel circuit and a driving method thereof, and a display panel, to improve the performance of the display panel.

According to one aspect of the present disclosure, a pixel circuit is provided. The pixel circuit includes:

a driving module;

a coupling module, and a first terminal of the coupling module is connected to a control terminal of the driving module; and

a data writing module, a first terminal of the data writing module is connected to a first terminal of the driving module, the first terminal of the data writing module is further connected to a second terminal of the coupling module, the data writing module is configured to transmit a data voltage to the second terminal of the coupling module, and the coupling module is configured to couple a voltage containing data voltage information at the second terminal of the coupling module to the control terminal of the driving module.

According to another aspect of the present disclosure, a driving method for a pixel circuit is provided. The pixel circuit includes a driving module, a coupling module, and a data writing module. A first terminal of the coupling module is connected to a control terminal of the driving module. A first terminal of the data writing module is connected to a first terminal of the driving module, and the first terminal of the data writing module is further connected to a second terminal of the coupling module.

The driving method includes:

in a data writing phase, the data writing module is turned on to transmit a data voltage to the second terminal of the coupling module, and the coupling module couples a voltage containing data voltage information at the second terminal of the coupling module to the control terminal of the driving module.

According to another aspect of the present disclosure, a display panel is provided. The display panel includes the pixel circuit according to any embodiment of the present disclosure.

In the embodiments of the present disclosure, by transmitting the data voltage to the second terminal of the coupling module when the data writing module is turned on, and coupling, via the coupling module, the voltage containing data voltage information at the second terminal of the coupling module to the control terminal of the driving module, direct writing of the data voltage is achieved without passing through the driving module. This can effectively reduce the required time for data writing, thereby enabling application to display panels with higher refresh rates. Moreover, during data writing, without passing through the driving module and a threshold compensation module, the data writing phase and the threshold compensation phase can be separated, ensuring the effectiveness of threshold compensation. This makes the driving current generated by the driving module independent of the threshold voltage of the transistor in the driving module. Under the same gray scale, the driving currents generated by different driving modules tend to be consistent, thereby improving the display uniformity of the display panel corresponding to the pixel circuit, further enhancing the display effect of the display panel, and improving the performance of the display panel.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

In order to illustrate the embodiments of the present disclosure more clearly, the following briefly introduces the drawings required for describing the embodiments. In one embodiment, the drawings in the following description are only some embodiments of the present disclosure.

FIG. 1 is a schematic structural diagram of a pixel circuit provided by an embodiment of the present disclosure;

FIG. 2 is a schematic structural diagram of another pixel circuit provided by an embodiment of the present disclosure;

FIG. 3 is a schematic structural diagram of yet another pixel circuit provided by an embodiment of the present disclosure;

FIG. 4 is a schematic structural diagram of yet another pixel circuit provided by an embodiment of the present disclosure;

FIG. 5 is a schematic structural diagram of yet another pixel circuit provided by an embodiment of the present disclosure;

FIG. 6 is a schematic structural diagram of yet another pixel circuit provided by an embodiment of the present disclosure;

FIG. 7 is a schematic structural diagram of yet another pixel circuit provided by an embodiment of the present disclosure;

FIG. 8 is a schematic structural diagram of yet another pixel circuit provided by an embodiment of the present disclosure;

FIG. 9 is a schematic structural diagram of yet another pixel circuit provided by an embodiment of the present disclosure;

FIG. 10 is a schematic structural diagram of yet another pixel circuit provided by an embodiment of the present disclosure;

FIG. 11 is a schematic structural diagram of yet another pixel circuit provided by an embodiment of the present disclosure;

FIG. 12 is a schematic structural diagram of yet another pixel circuit provided by an embodiment of the present disclosure;

FIG. 13 is a schematic structural diagram of yet another pixel circuit provided by an embodiment of the present disclosure;

FIG. 14 is a schematic structural diagram of yet another pixel circuit provided by an embodiment of the present disclosure;

FIG. 15 is a timing diagram of a pixel circuit provided by an embodiment of the present disclosure;

FIG. 16 is a timing diagram of another pixel circuit provided by an embodiment of the present disclosure;

FIG. 17 is a timing diagram of yet another pixel circuit provided by an embodiment of the present disclosure;

FIG. 18 is a flowchart of a driving method for a pixel circuit provided by an embodiment of the present disclosure;

FIG. 19 is a flowchart of another driving method for a pixel circuit provided by an embodiment of the present disclosure;

FIG. 20 is a flowchart of yet another driving method for a pixel circuit provided by an embodiment of the present disclosure;

FIG. 21 is a schematic structural diagram of a display panel provided by an embodiment of the present disclosure.

### DETAILED DESCRIPTION

In order to enable those to better understand the solutions of the present disclosure, the embodiments of the present disclosure will be clearly and completely described below with reference to the accompanying drawings in the embodiments of the present disclosure. In one embodiment, the described embodiments are only a part of the embodiments of the present disclosure, not all of them.

It should be noted that the terms "first", "second", etc., in the specification and claims of the present disclosure and the above drawings are used to distinguish similar objects and are not necessarily used to describe a specific order or sequence. It should be understood that the data used in this way may be interchanged under appropriate circumstances, and the embodiments of the present disclosure described herein can be implemented in an order other than those illustrated or described herein. In addition, the terms "comprising" and "having" and any variations thereof are intended to cover non-exclusive inclusion. For example, a process, method, system, product, or device that includes a series of steps or units is not necessarily limited to those steps or units that are clearly listed, but may include other steps or units that are not clearly listed or are inherent to these processes, methods, products, or devices.

As mentioned in the background technology, an existing display panel has a problem of usage performance that needs to be improved. Through research, the inventors found that the reason for the problem is that an active matrix organic light emitting diode display device emits light through current driving. A display device includes a display panel, the display panel includes a pixel circuit and a light emitting element, the pixel circuit is configured to generate a driving current, and drive the light emitting element to emit light. The pixel circuit includes a driving transistor, and the driving transistor is configured to generate the driving current. Therefore, the electrical characteristics of a driving transistor in a pixel circuit directly affect the grayscale brightness difference of a display device. When the electrical characteristic differences of driving transistors in different pixel circuits are too large, uneven picture quality is likely to result, such as a mura (i.e., uneven brightness of the display, causing various traces) phenomenon. In a related display device, the brightness uniformity of the entire display picture can be improved by performing internal compensation on the threshold voltage of a driving transistor in a pixel circuit.

However, in the related technology, threshold compensation is performed on a driving transistor while data is written, that is, a threshold compensation stage and a data writing stage are a same stage, making the duration of internal compensation for a threshold voltage easily affected by the resolution and a refresh frequency of the display panel, thereby possibly causing an insufficient compensation problem, in turn affecting the display effect of the display panel, and making the usage effect of the display panel poor.

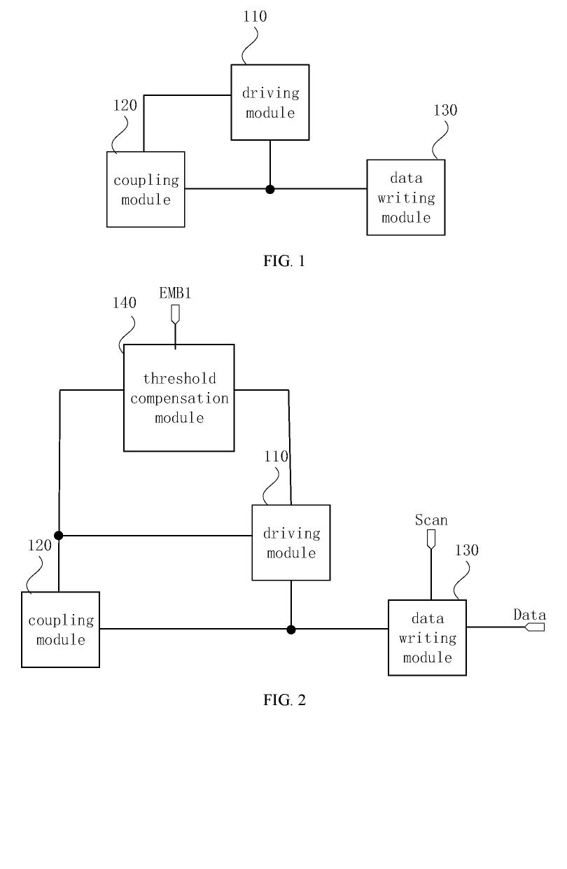

In view of the above problem, an embodiment of the present application provides a pixel circuit. FIG. 1 is a structural schematic diagram of a pixel circuit provided by an embodiment of the present application. Referring to FIG. 1, the pixel circuit includes:

a driving module 110;

a coupling module 120, and a first terminal of the coupling module 120 is connected to a control terminal of the driving module 110;

a data writing module 130, and a first terminal of the data writing module 130 is connected to a first terminal of the driving module 110, the first terminal of the data writing module 130 is further connected to a second terminal of the coupling module 120, and the data writing module 130 is configured to transmit a data voltage to the second terminal of the coupling module 120, and the coupling module 120 is configured to couple a voltage containing data voltage information at the second terminal of the coupling module 120 to the control terminal of the driving module 110.

In one embodiment, the driving module 110 may generate a driving current. The data writing module 130 may, when turned on, transmit the data voltage to the second terminal of the coupling module 120. The coupling module 120 may couple the voltage containing data voltage information at the second terminal of the coupling module 120 to the first terminal of the coupling module 120, i.e., couple to the control terminal of the driving module 110, thereby achieving writing of the data voltage. In this way, direct writing of the data voltage is achieved without passing through the driving module 110, which can effectively reduce the required time for data writing, thereby facilitating application to a display panel with a higher refresh frequency. And, when writing data, passing through the driving module 110 and a threshold compensation module is not necessary, and the data writing stage and the threshold compensation stage can be separated, then when the refresh frequency of the display panel is high, a longer threshold compensation time can still be set, thereby improving the threshold compensation effect. In this way, the driving current generated by the driving module 110 is made independent of the threshold voltage of a transistor in the driving module 110, then the electrical characteristics of a transistor in the driving module 110 will not affect the grayscale brightness difference of the display device, that is, under a same grayscale, driving currents generated by different driving modules 110 tend to be consistent, thereby improving the display uniformity of the display panel corresponding to the pixel circuit, in turn improving the display effect of the display panel, and improving the usage performance of the display panel. Moreover, direct writing of the data voltage can avoid a wrong charging phenomenon.

The embodiments of this embodiment, by transmitting the data voltage to the second terminal of the coupling module when the data writing module is turned on, and the coupling module coupling the voltage containing data voltage information at the second terminal of the coupling module to the control terminal of the driving module, achieves direct writing of the data voltage, without passing through the driving module, which can effectively reduce the required time for data writing, thereby facilitating application to a display panel with a higher refresh frequency. And, when writing data, passing through the driving module and the threshold compensation module is not necessary, the data writing stage and the threshold compensation stage can be separated, which can ensure the effect of threshold compensation, making the driving current generated by the driving module independent of the threshold voltage of a transistor in the driving module. Under a same grayscale, driving currents generated by different driving modules tend to be consistent, thereby improving the display uniformity of the display panel corresponding to the pixel circuit, in turn improving the display effect of the display panel, and improving the usage performance of the display panel.

Based on the above embodiments, FIG. 2 is a structural schematic diagram of another pixel circuit provided by an embodiment of the present application. In one embodiment, referring to FIG. 2, a control terminal of the data writing module 130 is connected to a scan line Scan, a second terminal of the data writing module 130 is connected to a data line Data, and the data writing module 130 is configured to, in a data writing stage, turn on in response to a scan signal on the scan line Scan to transmit the data voltage on the data line Data to the second terminal of the coupling module 120.

In one embodiment, the scan signal on the scan line Scan may control the data writing module 130 to turn on or turn off. In the data writing stage, the scan signal on the scan line Scan may control the data writing module 130 to turn on, and the data writing module 130 transmits the data voltage on the data line Data to the second terminal of the coupling module 120. And, the data writing stage is a separate stage, the data writing stage can be separated from a threshold compensation stage, facilitating separate control of the duration of the threshold compensation stage.

In one embodiment, referring to FIG. 2, the pixel circuit further includes:

a threshold compensation module 140, the threshold compensation module 140 is connected between the control terminal of the driving module 110 and a second terminal of the driving module 110; the threshold compensation module 140 is configured to turn on in a compensation stage to perform threshold compensation on the driving module 110.

In one embodiment, the compensation stage is the threshold compensation stage. In the compensation stage, the threshold compensation module 140 is turned on to perform threshold compensation on the driving module 110. Thereby, the compensation stage and the data writing stage are separated, and the duration of the compensation stage can be controlled separately, and when the refresh frequency of the display panel corresponding to the pixel circuit is high, a longer compensation time can also be set, thereby ensuring the threshold compensation effect, making the driving current generated by the driving module 110 independent of the threshold voltage of a transistor in the driving module 110, then the electrical characteristics of a transistor in the driving module 110 will not affect the grayscale brightness difference of the display device, that is, under a same grayscale, driving currents generated by different driving modules 110 tend to be consistent, thereby improving the display uniformity of the display panel corresponding to the pixel circuit.

In one embodiment, referring to FIG. 2, a control terminal of the threshold compensation module 140 is connected to a first control line EMB1, and the threshold compensation module 140 is configured to, in the compensation stage, turn on in response to a first control signal on the first control line EMB1 to perform threshold compensation on the driving module 110.

In one embodiment, in the compensation stage, the first control signal on the first control line EMB1 controls the threshold compensation module 140 to turn on, facilitating charging or discharging of the first terminal of the coupling module 120 through the threshold compensation module 140 and the driving module 110, and the voltage at the first terminal of the coupling module 120 becomes a voltage related to the threshold voltage of a transistor in the driving module 110, that is, making the voltage at the control terminal of the driving module 110 a voltage related to the threshold voltage of a transistor in the driving module 110, making a voltage difference Vgs between the control terminal of the driving module 110 and the first terminal of the driving module 110 a voltage related to a threshold voltage Vth of a transistor in the driving module 110, and the driving current generated by the driving module 110 is related to the difference of Vgs (the voltage difference between the control terminal of the driving module 110 and the first terminal of the driving module 110) minus the threshold voltage Vth of a transistor in the driving module 110, thereby being able to cancel out the threshold voltage, making the driving current independent of the threshold voltage of a transistor in the driving module 110, and achieving threshold compensation for the driving module 110.

In one embodiment, the compensation stage is located before the data writing stage. In this way, the compensation stage and the data writing stage can be separated, and the duration of the compensation stage can be controlled separately, and when the refresh frequency of the display panel corresponding to the pixel circuit is high, a longer compensation time can also be set, thereby ensuring the threshold compensation effect.

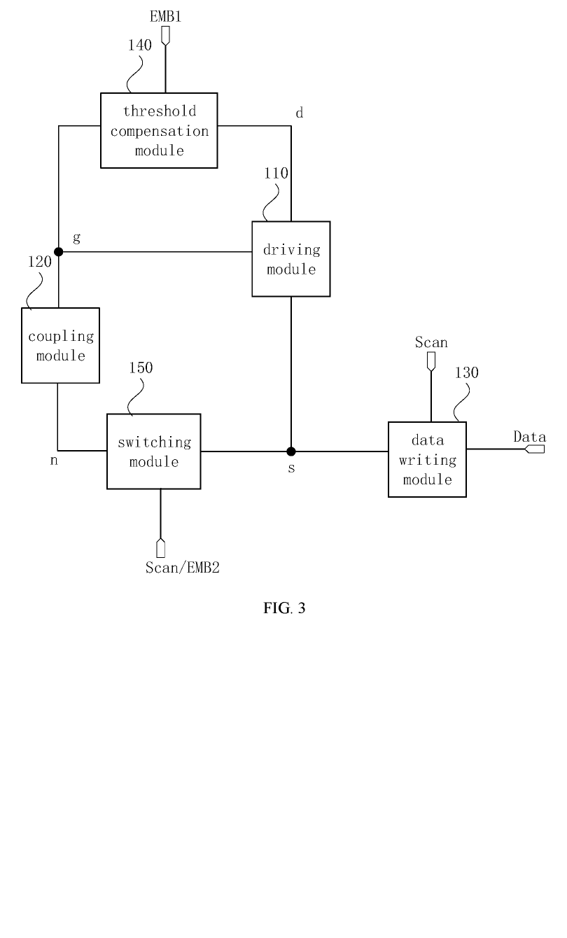

Based on the above embodiments, FIG. 3 is a structural schematic diagram of yet another pixel circuit provided by an embodiment of the present application. In one embodiment, referring to FIG. 3, the pixel circuit further includes:

a switching module 150, a first terminal of the switching module 150 is connected to the first terminal of the data writing module 130, a second terminal of the switching module 150 is connected to the second terminal of the coupling module 120, and a control terminal of the switching module 150 is connected to the scan line Scan or a second control line EMB2; the data writing module 130 is configured to, in the data writing stage, transmit the data voltage to the first terminal of the switching module 150, and the switching module 150 is configured to transmit the data voltage to a second terminal n of the coupling module 120.

In one embodiment, a scan signal on the scan line Scan or a second control signal on the second control line EMB2 may control the switching module 150 to turn on or turn off (i.e., be turned off). In the data writing stage, the scan signal on the scan line Scan controls the data writing module 130 to turn on, and the scan signal on the scan line Scan or the second control signal on the second control line EMB2 controls the switching module 150 to turn on, and the data writing module 130 transmits the data voltage on the data line Data to the first terminal of the switching module 150 (i.e., a first terminal s of the driving module 110), and the switching module 150 transmits the data voltage to the second terminal n of the coupling module 120, facilitating the coupling module 120 to couple the voltage containing data voltage information at the second terminal of the coupling module 120 to a control terminal g of the driving module 110.

And, when writing data, there is only one switching module 150 between the data writing module 130 and the coupling module 120, and the equivalent resistance of the switching module 150 is small, which can effectively reduce the time required for data writing, facilitating application of the pixel circuit in a display panel of a higher refresh frequency.

In one embodiment, a waveform of an active level of the second control signal on the second control line EMB2 is the same as a waveform of an active level of the first control signal on the first control line EMB1; the active level of the second control signal on the second control line EMB2, relative to the active level of the first control signal on the first control line EMB1, is delayed by one line time.

And, one line time can be calculated according to the resolution and refresh rate of the display panel, the number of rows of the pixel circuit can be determined according to the resolution, then one line time is 1/(refresh rate * number of rows of the pixel circuit).

In one embodiment, a display panel formed by the pixel circuit includes a plurality of cascaded connected first shift registers, a first shift register may be connected to the scan line Scan, and the first shift register outputs a scan signal. The display panel corresponding to the pixel circuit further includes a plurality of cascaded connected second shift registers, a plurality of pixel circuits in the display panel are arranged in an array, the second control line EMB2 and the first control line EMB1 extend along a row direction, one second control line EMB2 is correspondingly connected to one row of pixel circuits, and one first control line EMB1 is correspondingly connected to one row of pixel circuits. For example, an m-th stage second shift register is connected to the first control line EMB1 corresponding to an m-th row of pixel circuits, and is connected to the second control line EMB2 corresponding to an (m-1)-th row of pixel circuits, or, the m-th stage second shift register is connected to the first control line EMB1 corresponding to an (m+1)-th row of pixel circuits, and is connected to the second control line EMB2 corresponding to the m-th row of pixel circuits. This enables the second control line EMB2 and the first control line EMB1 to share one group of second shift registers, thereby reducing the number of shift registers, which is beneficial to achieving a narrow bezel. In one embodiment, m is an integer greater than 1.

Based on the some embodiments, possible structures of each module are described below, but are not intended as limitations on the present application.

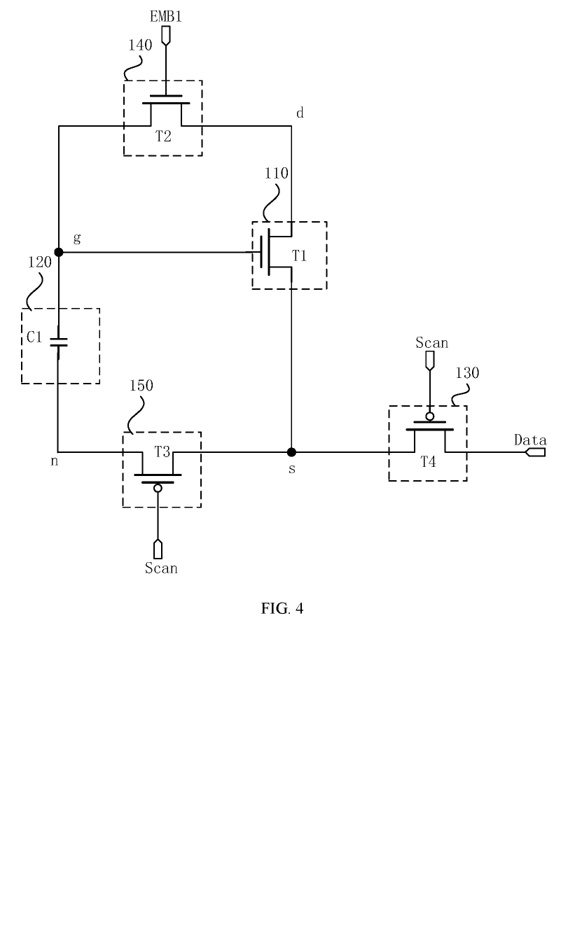

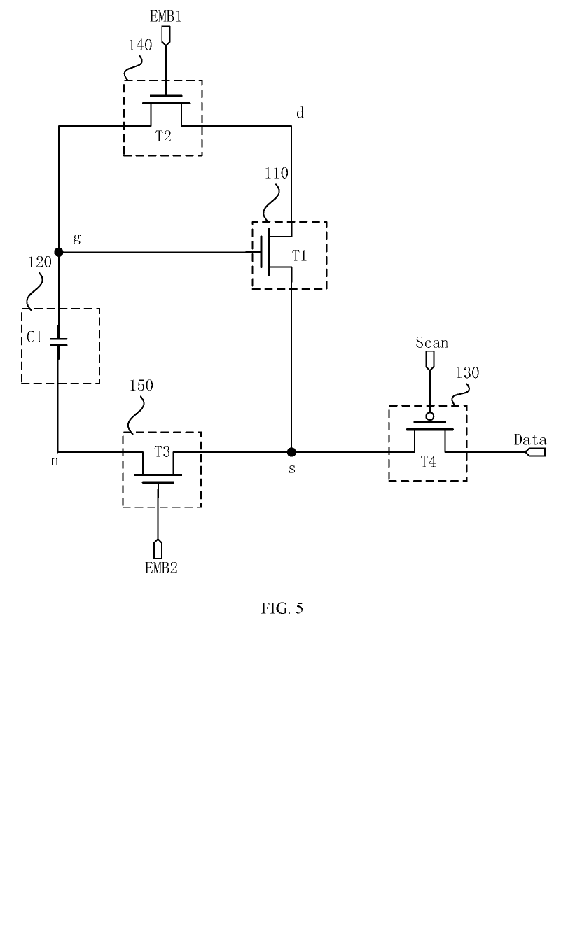

FIG. 4 is a structural schematic diagram of yet another pixel circuit provided by an embodiment of the present application, and FIG. 5 is a structural schematic diagram of yet another pixel circuit provided by an embodiment of the present application. In one embodiment, referring to FIG. 4 or FIG. 5, the driving module 110 includes a first transistor T1, a control electrode g of the first transistor T1 is connected to the first terminal of the coupling module 120, a first electrode s of the first transistor T1 is connected to the first terminal of the data writing module 130, and a second electrode d of the first transistor T1 is connected to the threshold compensation module 140.

In one embodiment, the first electrode s of the first transistor T1 is a source electrode, and the second electrode d of the first transistor T1 is a drain electrode, or, the first electrode of the first transistor T1 is a drain electrode d, and the second electrode of the first transistor T1 is a source electrode s, which this embodiment does not limit. The first transistor T1 may generate a driving current to drive a corresponding light emitting module to emit light.

In one embodiment, referring to FIG. 4 or FIG. 5, the threshold compensation module 140 includes a second transistor T2, the second transistor T2 is connected between the control terminal g of the driving module 110 and the second terminal d of the driving module 110, and a control electrode of the second transistor T2 is connected to the first control line EMB1.

In one embodiment, a first electrode of the second transistor T2 is a source electrode, and a second electrode of the second transistor T2 is a drain electrode, or, a first electrode of the second transistor T2 is a drain electrode, and a second electrode of the second transistor T2 is a source electrode, which this embodiment does not limit. When the first control line EMB1 controls the second transistor T2 to turn on, threshold compensation is facilitated for the driving module 110.

In one embodiment, referring to FIG. 4 or FIG. 5, the switching module 150 includes a third transistor T3, a first electrode of the third transistor T3 is connected to the first terminal of the data writing module 130, a second electrode of the third transistor T3 is connected to the second terminal n of the coupling module 120, and a control electrode of the third transistor T3 is connected to the scan line Scan or the second control line EMB2.

In one embodiment, a first electrode of the third transistor T3 is a source electrode, and a second electrode of the third transistor T3 is a drain electrode, or, a first electrode of the third transistor T3 is a drain electrode, and a second electrode of the third transistor T3 is a source electrode, which this embodiment does not limit. When the scan signal on the scan line Scan or the second control signal on the second control line EMB2 controls the third transistor T3 to turn on, the third transistor T3 may transmit the data voltage at the first terminal of the data writing module 130 to the second terminal n of the coupling module 120, facilitating the coupling module 120 to couple the voltage related to the data voltage at the second terminal n of the coupling module 120 to the control terminal g of the driving module 110.

In one embodiment, referring to FIG. 4 or FIG. 5, the data writing module 130 includes a fourth transistor T4, a first electrode of the fourth transistor T4 is connected to the first terminal s of the driving module 110, a second electrode of the fourth transistor T4 is connected to the data line Data, and a control electrode of the fourth transistor T4 is connected to the scan line Scan.

In one embodiment, a first electrode of the fourth transistor T4 is a source electrode, and a second electrode of the fourth transistor T4 is a drain electrode, or, a first electrode of the fourth transistor T4 is a drain electrode, and a second electrode of the fourth transistor T4 is a source electrode, which this embodiment does not limit. The fourth transistor T4 may be an N-type transistor, or may be a P-type transistor, and FIG. 4 and FIG. 5 show a case where the fourth transistor T4 is a P-type transistor, but this is not limiting. In the data writing stage, when the scan signal on the scan line Scan controls the fourth transistor T4 to turn on, the fourth transistor T4 may transmit the data voltage on the data line Data to the first terminal s of the driving module 110. The data writing stage is a separate stage, and the duration for which the scan signal on the scan line Scan controls the fourth transistor T4 in one row of pixel circuits to turn on may be greater than or equal to one line time, which can increase the data writing time and ensure that the data voltage is written to the first electrode s of the first transistor T1.

In one embodiment, referring to FIG. 4, the type of the third transistor T3 is the same as the type of the fourth transistor T4, and the control electrode of the third transistor T3 is connected to the scan line Scan. For example, both the third transistor T3 and the fourth transistor T4 are P-type transistors, which can achieve sharing of the scan line Scan, can reduce the number of signal lines, is beneficial to reducing occupied space, and facilitates improving the pixel density of the display panel corresponding to the pixel circuit.

In another embodiment, referring to FIG. 5, the type of the third transistor T3 is the same as the type of the second transistor T2, and the control electrode of the third transistor T3 is connected to the second control line EMB2. For example, both the second transistor T2 and the third transistor T3 are N-type transistors, the control electrode of the third transistor T3 is connected to the second control line EMB2, a waveform of an active level of a second control signal on the second control line EMB2 is the same as a waveform of an active level of a first control signal on the first control line EMB1; and the active level of the second control signal on the second control line EMB2, relative to the active level of the first control signal on the first control line EMB1, is delayed by one line time, thereby enabling the first control line EMB1 and the second control line EMB2 to share one group of shift registers (a second shift register), which is beneficial to achieving a narrow bezel of the display panel.

In one embodiment, referring to FIG. 4 or FIG. 5, the coupling module 120 includes a first capacitor C1, a first electrode of the first capacitor C1 is connected to the control terminal g of the driving module 110, and a second electrode n of the first capacitor C1 is connected to the second terminal of the switching module 150. Because the first capacitor C1 can store a voltage, that is, the voltage difference across the two terminals of the first capacitor C1 remains unchanged, when the voltage at the second electrode n of the first capacitor C1 changes, the first electrode of the first capacitor C1 will also change, thereby facilitating, after the data voltage is written to the second electrode n of the first capacitor C1, the first capacitor C1 to couple the voltage containing data voltage information at the second electrode n of the first capacitor C1 to the first electrode of the first capacitor C1, that is, couple to the control terminal g of the driving module 110, thereby achieving writing of the data voltage.

In one embodiment, referring to FIG. 4 or FIG. 5, the first transistor T1 is an N-type transistor. The first transistor T1 may be an oxide transistor, for example, an indium gallium zinc oxide (IGZO) transistor or an indium zinc oxide (IZO) transistor, which this embodiment does not limit.

In one embodiment, referring to FIG. 4 or FIG. 5, the second transistor T2 is an N-type transistor. The second transistor T2 may be an oxide transistor, for example, an indium gallium zinc oxide (IGZO) transistor or an indium zinc oxide (IZO) transistor, which this embodiment does not limit. By setting the second transistor T2 to be an N-type transistor, the leakage current of the control terminal g of the driving module 110 can be reduced, enabling the driving module 110 to generate a stable driving current.

Based on the above some embodiments, structures that the pixel circuit may also include are described below, but are not intended as limitations on the present application.

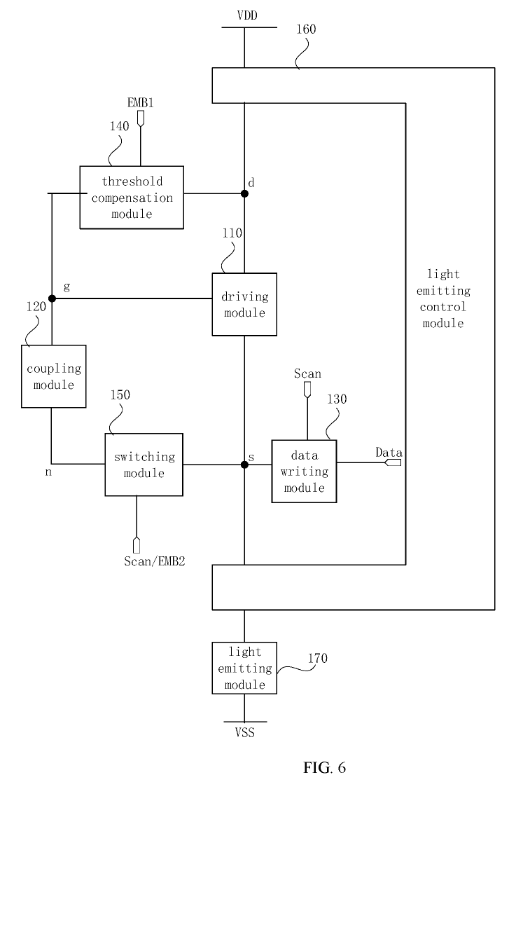

FIG. 6 is a structural schematic diagram of yet another pixel circuit provided by an embodiment of the present application. In one embodiment, referring to FIG. 6, the pixel circuit further includes:

a light emitting control module 160 and a light emitting module 170, the driving module 110, the light emitting control module 160 and the light emitting module 170 are connected in series between a first power line VDD and a second power line VSS;

a switching module 150, a first terminal of the switching module 150 is connected to the first terminal of the data writing module 130, a second terminal of the switching module 150 is connected to the second terminal of the coupling module 120, and a control terminal of the switching module 150 is connected to the scan line Scan or a second control line EMB2.

In one embodiment, the light emitting module 170 may include an organic light emitting diode.

In one embodiment, the light emitting control module 160 may control whether the driving module 110 generates a driving current. In a light emitting stage, the light emitting control module 160 is turned on, and the first power line VDD, the light emitting control module 160, the driving module 110, the light emitting module 170 and the second power line VSS form a current loop, facilitating the driving module 110 to generate a driving current, and the light emitting module 170 emits light in response to the driving current.

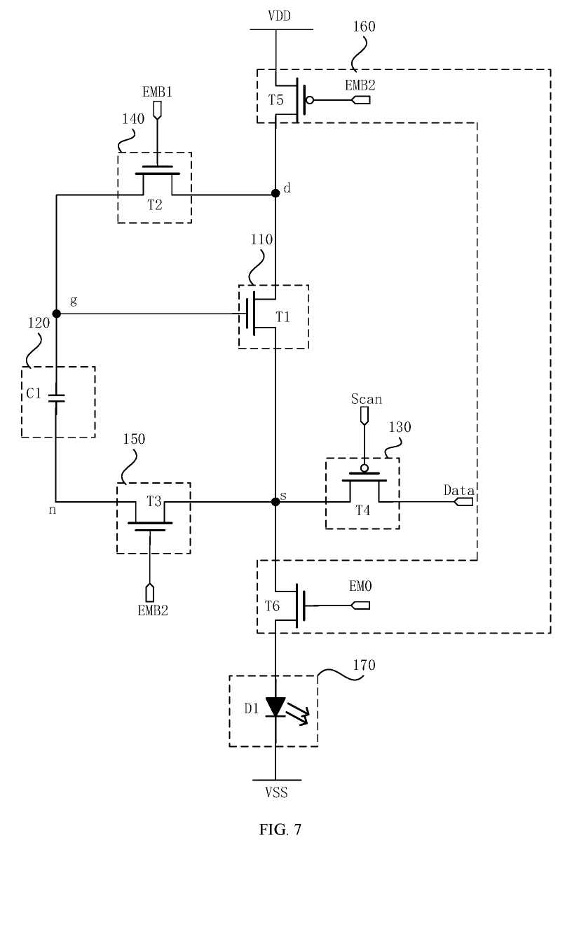

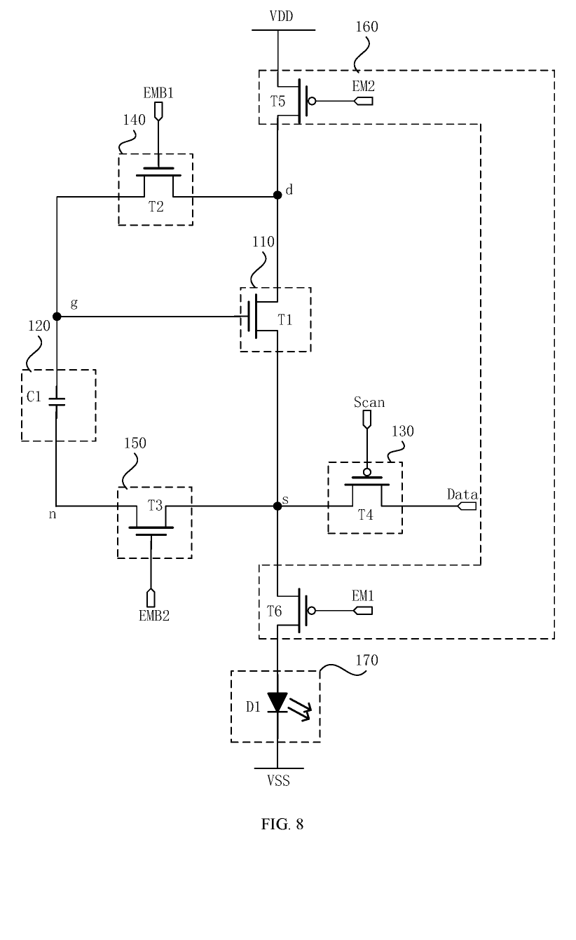

FIG. 7 is a structural schematic diagram of yet another pixel circuit provided by an embodiment of the present application, and FIG. 8 is a structural schematic diagram of yet another pixel circuit provided by an embodiment of the present application. In one embodiment, referring to FIG. 7 or FIG. 8, the light emitting control module 160 includes a fifth transistor T5 and a sixth transistor T6;

the fifth transistor T5 is connected between the first power line VDD and the second terminal of the driving module 110; the fifth transistor T5 is configured to turn on in a reset stage and a light emitting stage;

the sixth transistor T6 is connected between the first terminal of the driving module 110 and a first terminal of the light emitting module 170; the sixth transistor T6 is configured to turn on in the light emitting stage;

referring to FIG. 7, the type of the fifth transistor T5 is different from the type of the sixth transistor T6, a control electrode of the fifth transistor T5 is connected to the second control line EMB2, and a control electrode of the sixth transistor T6 is connected to a fourth control line EM0; or, referring to FIG. 8, the type of the fifth transistor T5 is the same as the type of the sixth transistor T6, a control electrode of the fifth transistor T5 is connected to a third control line EM2, and a control electrode of the sixth transistor T6 is connected to a fifth control line EM1;

a second terminal of the light emitting module 170 is connected to the second power line VSS.

In one embodiment, the first power line VDD may transmit a first power voltage, and the second power line VSS may transmit a second power voltage. The first power voltage is a positive voltage, and the second power voltage is zero or a negative voltage; or, the first power voltage is zero or a negative voltage, and the second power voltage is a positive voltage.

In one embodiment, in the reset stage, the fifth transistor T5 is turned on, and the fifth transistor T5 transmits the first power voltage to the second terminal d of the driving module 110. If the threshold compensation module 140 is turned on, the first power voltage may charge the first terminal of the coupling module 120 through the threshold compensation module 140, facilitating resetting of the control terminal g of the driving module 110, and facilitating control of the driving module 110 to turn on, for facilitating subsequent threshold compensation.

In the light emitting stage, the fifth transistor T5 and the sixth transistor T6 turn on, and the first power line VDD, the fifth transistor T5, the driving module 110, the sixth transistor T6, the light emitting module 170 and the second power line VSS may form a current loop, enabling the driving module 110 to generate a driving current.

In some embodiments, as shown in FIG. 7, the type of the fifth transistor T5 is different from the type of the sixth transistor T6, for example, the fifth transistor T5 is a P-type transistor, the sixth transistor T6 is an N-type transistor, a control electrode of the fifth transistor T5 is connected to the second control line EMB2, and a control electrode of the sixth transistor T6 is connected to the fourth control line EM0, and the fifth transistor T5 and the switching module 150 may share the second control line EMB2, which is beneficial to reducing the number of signal lines, reducing occupied space, and facilitating improving the pixel density of the display panel.

In some embodiments, as shown in FIG. 8, the type of the fifth transistor T5 is the same as the type of the sixth transistor T6, for example, both the fifth transistor T5 and the sixth transistor T6 are P-type transistors. A control electrode of the fifth transistor T5 is connected to a third control line EM2, and a control electrode of the sixth transistor T6 is connected to a fifth control line EM1.

In one embodiment, a waveform of an active level of a third control signal on the third control line EM2 is the same as a waveform of an active level of a fifth control signal on the fifth control line EM1; the active level of the third control signal on the third control line EM2, relative to the active level of the fifth control signal on the fifth control line EM1, is delayed by one line time.

Exemplarily, the display panel corresponding to the pixel circuit further includes a plurality of cascadedly connected third shift registers. For example, an m-th stage third shift register is connected to the fifth control line EM1 corresponding to an m-th row of pixel circuits, and is connected to the third control line EM2 corresponding to an (m-1)-th row of pixel circuits, or, an m-th stage second shift register is connected to the fifth control line EM1 corresponding to an (m+1)-th row of pixel circuits, and is connected to the third control line EM2 corresponding to the m-th row of pixel circuits. This enables the third control line EM2 and the fifth control line EM1 to share one group of shift registers, thereby reducing the number of shift registers, which is beneficial to achieving a narrow bezel. And, m is an integer greater than 1.

Based on the some embodiments, in one embodiment, referring to FIG. 7 or FIG. 8, the pixel circuit further includes:

a threshold compensation module 140, the threshold compensation module 140 is connected between the control terminal of the driving module 110 and the second terminal of the driving module 110; the threshold compensation module 140 is configured to turn on in a compensation stage to perform threshold compensation on the driving module;

the threshold compensation module 140 includes a second transistor T2, and the type of the second transistor T2 is different from the type of the fifth transistor T5.

Exemplarily, as shown in FIG. 7 or FIG. 8, the second transistor T2 is an N-type transistor, which can reduce the leakage current of the control terminal of the driving module 110, and the fifth transistor T5 is a P-type transistor, which can reduce cost.

In one embodiment, referring to FIG. 7 or FIG. 8, the light emitting module 170 includes an organic light emitting diode D1, a first electrode of the organic light emitting diode D1 is connected to the sixth transistor T6, and a second electrode of the organic light emitting diode D1 is connected to the second power line VSS. In one embodiment, the first electrode of the organic light emitting diode D1 is an anode, and the second electrode of the organic light emitting diode D1 is a cathode; or, the first electrode of the organic light emitting diode D1 is a cathode, and the second electrode of the organic light emitting diode D1 is an anode, which this embodiment does not limit. The organic light emitting diode D1 may emit light in response to a driving current generated by a corresponding driving module 110.

In one embodiment, referring to FIG. 7 or FIG. 8, the reset stage is located before the compensation stage. With this arrangement, the control terminal g of the driving module 110 can be reset before performing threshold compensation on the driving module 110, avoiding the influence of a residual charge from a previous frame on threshold compensation and light emission. And it can be ensured that the driving module 110 is controlled to turn on in the reset stage before the compensation stage, facilitating threshold compensation of the driving module 110 in the compensation stage.

Structures that the pixel circuit may also include are described below, but are not intended as limitations on the present application.

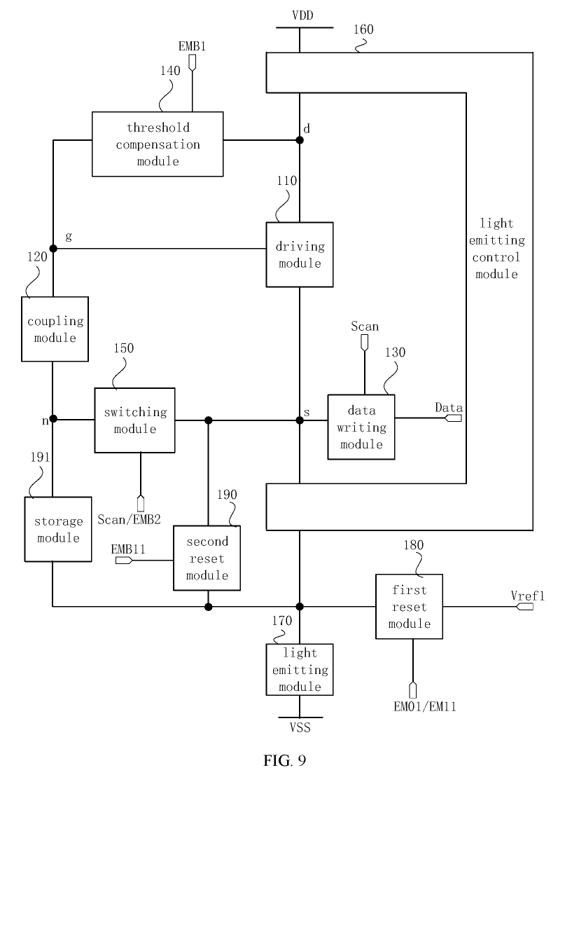

In one embodiment, FIG. 9 is a structural schematic diagram of yet another pixel circuit provided by an embodiment of the present application. In one embodiment, referring to FIG. 9, the pixel circuit further includes:

a first reset module 180 and a light emitting module 170, a first terminal of the first reset module 180 is connected to a first reset signal line Vref1, a second terminal of the first reset module 180 is connected to a first terminal of the light emitting module 170; a control terminal of the first reset module 180 is connected to a sixth control line EM01 or a seventh control line EM11; the first reset module 180 is configured to turn on in a reset stage, a compensation stage and a data writing stage;

a second reset module 190, the second reset module 190 is connected between the second terminal of the first reset module 180 and the first terminal s of the driving module 110, a control terminal of the second reset module 190 is connected to an eighth control line EMB11; the second reset module 190 is configured to turn on in the reset stage and the compensation stage.

In one embodiment, in the reset stage, the first reset module 180 is turned on, and the first reset module 180 transmits a first reset voltage on the first reset signal line Vref1 to the first terminal of the light emitting module 170, to reset the first terminal of the light emitting module 170. And the second reset module 190 is turned on, and the second reset module 190 may transmit the first reset voltage at the first terminal of the light emitting module 170 to the first terminal s of the driving module 110, to reset the first terminal s of the driving module 110. And this makes the voltage at the first terminal s of the driving module 110 small, facilitating turning on of the driving module 110. In the compensation stage, the driving module 110, the threshold compensation module 140, the first reset module 180 and the second reset module 190 turn on, and the first terminal of the coupling module 120 discharges through the threshold compensation module 140, the driving module 110, the second reset module 190 and the first reset module 180, until the voltage at the control terminal g of the driving module 110 is the sum of the first reset voltage and the threshold voltage of a transistor in the driving module 110, and the driving module 110 is turned off, thereby making the voltage at the control terminal of the driving module 110 a voltage related to the threshold voltage of a transistor in the driving module 110, and achieving threshold compensation.

And, the first reset module 180 is turned on in the data writing stage, which can maintain the voltage at the first terminal of the light emitting module 170.

In one embodiment, the threshold compensation module 140 is also configured to turn on in the reset stage. In this way, in the reset stage, a first power voltage on the first power line VDD charges the first terminal of the coupling module 120 through a fifth transistor T5 in the light emitting control module 160 and the threshold compensation module 140, making the voltage at the control terminal g of the driving module 110 large, while the voltage at the first terminal s of the driving module 110 is small, and the voltage difference between the control terminal g of the driving module 110 and the first terminal s of the driving module 110 satisfies the turn-on condition of the driving module 110, then the driving module 110 can be made to turn on, facilitating performing threshold compensation on the driving module 110 in a subsequent compensation stage.

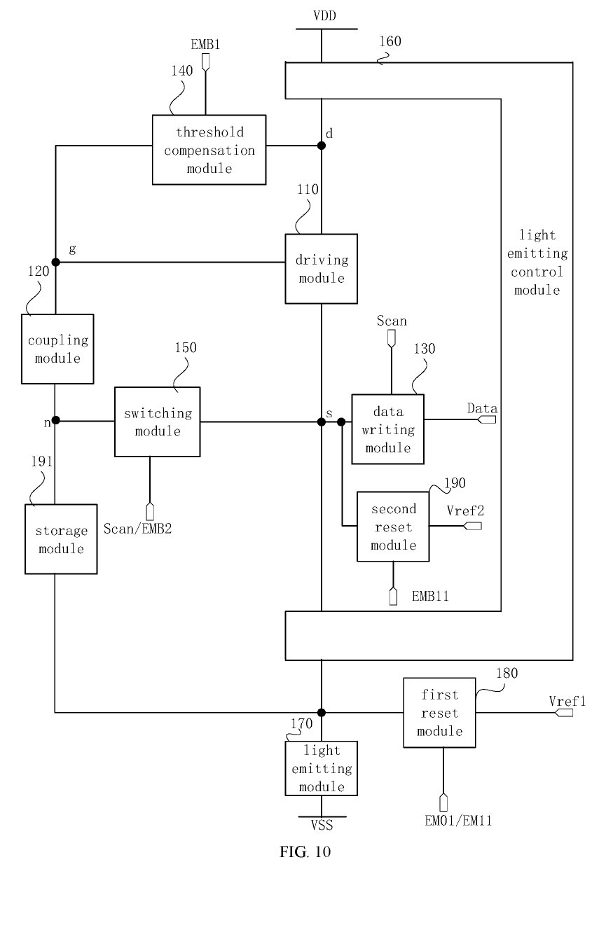

In another embodiment, FIG. 10 is a structural schematic diagram of yet another pixel circuit provided by an embodiment of the present application. In one embodiment, referring to FIG. 10, the pixel circuit further includes:

a second reset module 190, the second reset module 190 is connected between a second reset signal line Vref2 and the first terminal of the driving module 110, a control terminal of the second reset module 190 is connected to an eighth control line EMB11; the second reset module 190 is configured to, in a reset stage and a compensation stage, transmit a second reset voltage on the second reset signal line Vref2 to the first terminal s of the driving module 110.

In one embodiment, in the reset stage, the second reset module 190 transmits a second reset voltage on the second reset signal line Vref2 to the first terminal s of the driving module 110, to reset the first terminal s of the driving module 110. And this makes the voltage at the first terminal s of the driving module 110 small, facilitating making the voltage difference between the control terminal g of the driving module 110 and the first terminal s of the driving module 110 satisfy the turn-on condition of the driving module 110, and the driving module 110 can turn on in the compensation stage, for facilitating threshold compensation of the driving module 110. In the compensation stage, the driving module 110, the threshold compensation module 140 and the second reset module 190 turn on, and the first terminal of the coupling module 120 discharges through the threshold compensation module 140, the driving module 110 and the second reset module 190, until the voltage at the control terminal g of the driving module 110 is the sum of the second reset voltage and the threshold voltage of a transistor in the driving module 110, and the driving module 110 is turned off, thereby making the voltage at the control terminal of the driving module 110 a voltage related to the threshold voltage of a transistor in the driving module 110, and achieving threshold compensation.

In one embodiment, the threshold compensation module 140 is also configured to turn on in the reset stage. In this way, in the reset stage, a first power voltage on the first power line VDD charges the first terminal of the coupling module 120 through a fifth transistor T5 in the light emitting control module 160 and the threshold compensation module 140, making the voltage at the control terminal g of the driving module 110 large, while the voltage at the first terminal s of the driving module 110 is small, and the voltage difference between the control terminal g of the driving module 110 and the first terminal s of the driving module 110 satisfies the turn-on condition of the driving module 110, then the driving module 110 can be made to turn on, facilitating performing threshold compensation on the driving module 110 in a subsequent compensation stage.

In one embodiment, referring to FIG. 10, the pixel circuit further includes:

a first reset module 180 and a light emitting module 170, a first terminal of the first reset module 180 is connected to a first reset signal line Vref1, a second terminal of the first reset module 180 is connected to a first terminal of the light emitting module 170; a control terminal of the first reset module 180 is connected to a sixth control line EM01 or a seventh control line EM11; the first reset module 180 is configured to turn on in a reset stage, a compensation stage and a data writing stage.

In one embodiment, in the reset stage, the compensation stage and the data writing stage, the first reset module 180 is turned on, and the first reset module 180 transmits a first reset voltage on the first reset signal line Vref1 to the first terminal of the light emitting module 170, to reset the first terminal of the light emitting module 170.

In one embodiment, referring to FIG. 9 or FIG. 10, the pixel circuit further includes:

a storage module 191, the storage module 191 is connected between the second terminal of the first reset module 180 and the second terminal n of the coupling module 120; the storage module 191 is configured to store the data voltage.

In one embodiment, for example, a first terminal of the storage module 191 is connected to the second terminal of the coupling module 120, and a second terminal of the storage module 191 is connected to the second terminal of the first reset module 180. In the data writing stage, the data writing module 130 transmits a data voltage Vdata to the first terminal s of the driving module 110, and the switching module 150 transmits the data voltage Vdata to the second terminal n of the coupling module 120, that is, the voltage at the first terminal of the storage module 191 is the data voltage Vdata, i.e., Vn=Vdata. Because the first reset module 180 transmits the first reset voltage to the second terminal of the storage module 191, maintaining the voltage at the second terminal of the storage module 191, the storage module 191 thereby stores the data voltage Vdata, facilitating the coupling module 120 to couple a voltage related to the data voltage Vdata to the control terminal g of the driving module 110.

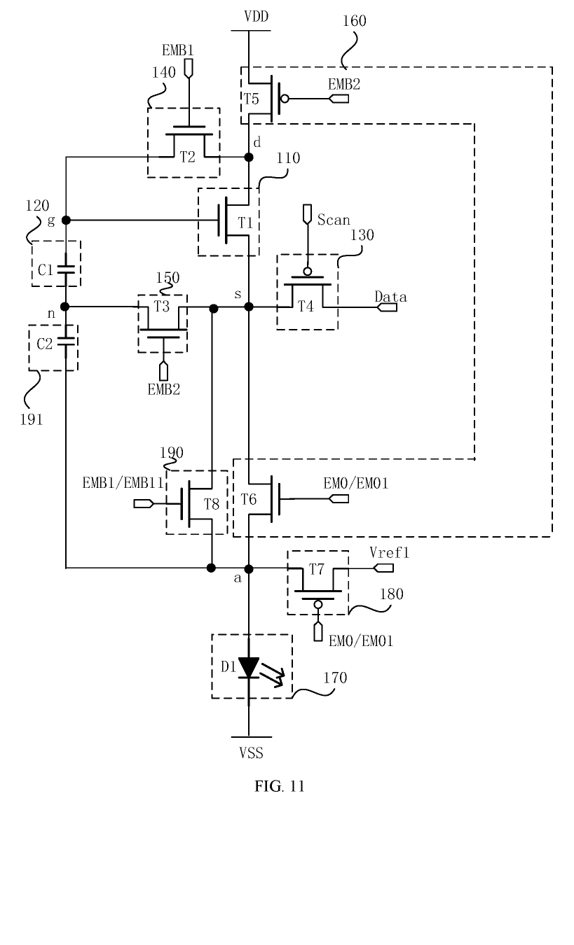

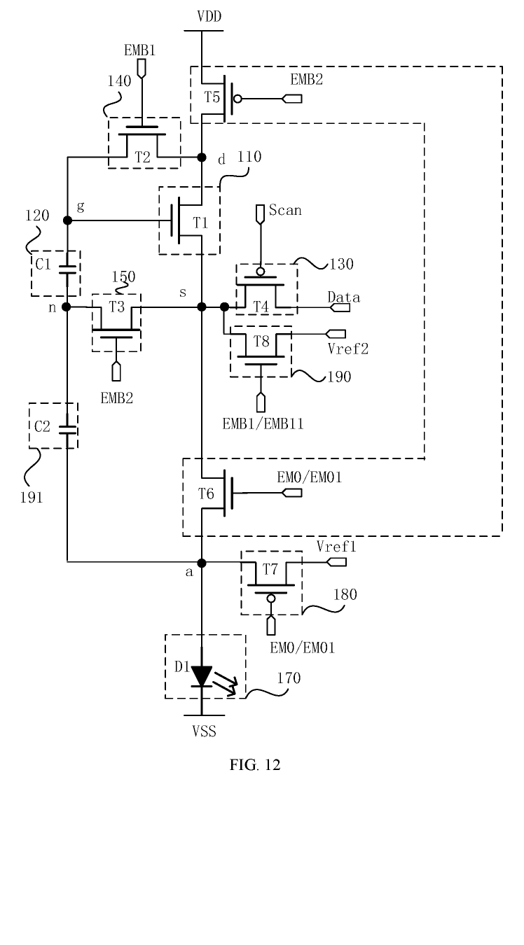

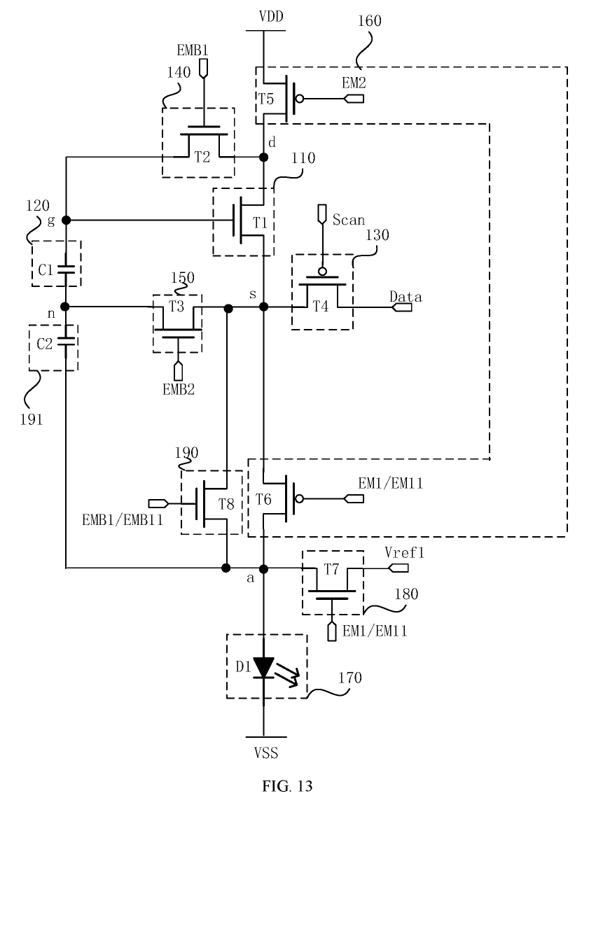

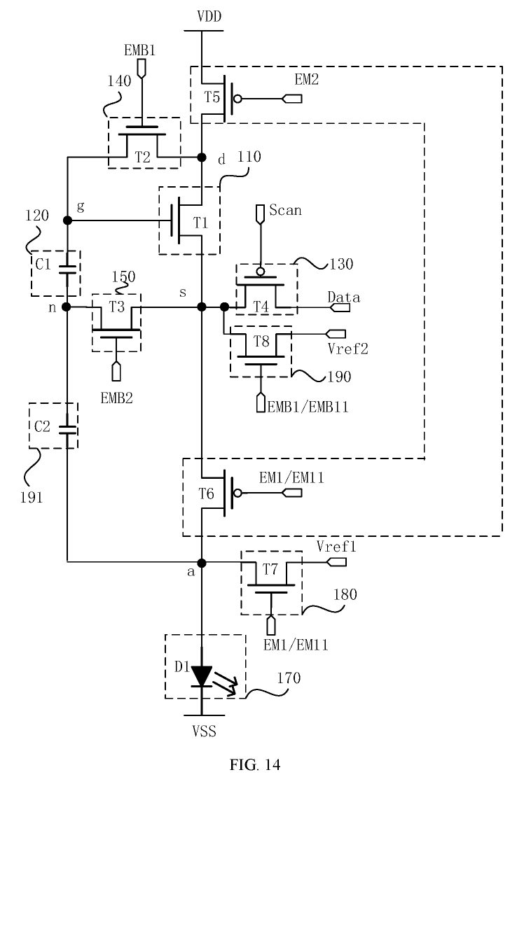

Based on the some embodiments, FIG. 11 is a structural schematic diagram of yet another pixel circuit provided by an embodiment of the present application, FIG. 12 is a structural schematic diagram of yet another pixel circuit provided by an embodiment of the present application, FIG. 13 is a structural schematic diagram of yet another pixel circuit provided by an embodiment of the present application, and FIG. 14 is a structural schematic diagram of yet another pixel circuit provided by an embodiment of the present application. In one embodiment, referring to FIG. 11, FIG. 12, FIG. 13 or FIG. 14, the storage module 191 includes a second capacitor C2, the second capacitor C2 is connected between the second terminal of the first reset module 180 and the second terminal of the coupling module 120. The second capacitor C2 may store the data voltage.

In one embodiment, referring to FIG. 10, a second terminal of the light emitting module 170 is connected to the second power line VSS, and the first reset voltage is less than the sum of a second power voltage on the second power line VSS and a turn-on voltage of the light emitting module 170;

a second terminal d of the driving module 110 is connected to the first power line VDD, and the second reset voltage is less than the difference between a first power voltage on the first power line VDD and a threshold voltage of a transistor in the driving module 110.

In one embodiment, the first reset voltage being less than the sum of the second power voltage on the second power line VSS and the turn-on voltage of the light emitting module 170, that is, the difference between the first reset voltage and the second power voltage is less than the turn-on voltage of the light emitting module 170, and before a light emitting stage (a reset stage, a compensation stage and a data writing stage), the light emitting module 170 will not emit light.

For example, a transistor in the driving module 110 is an N-type transistor. The second reset voltage being less than the difference between the first power voltage and the threshold voltage of a transistor in the driving module 110, that is, the first power voltage is greater than the sum of the second reset voltage and the threshold voltage of a transistor in the driving module 110, and in the reset stage, a voltage Vg at the control terminal of the driving module 110 is greater than the sum of a second reset voltage Vr2 and a threshold voltage Vth of a transistor in the driving module 110, i.e., Vg>Vr2+Vth, which can ensure that the driving module 110 is turned on, for facilitating subsequent threshold compensation of the driving module 110.

In one embodiment, the second reset voltage is greater than the first reset voltage. For example, the first power voltage is greater than the second power voltage, the second reset voltage is less than the difference between the first power voltage and the threshold voltage of a transistor in the driving module 110, and the first reset voltage is less than the sum of the second power voltage and the turn-on voltage of the light emitting module 170, then the second reset voltage need not be too small, that is, the second reset voltage can be greater than the first reset voltage. A larger second reset voltage results in the difference between the second reset voltage and the first power voltage not being too large, and in the reset stage, after the driving module 110 is turned on, the current between the first power line, the light emitting control module 160, the driving module 110 and the second reset module 190 is small, which can reduce power consumption waste.

Based on the some embodiments, in one embodiment, the pixel circuit further includes a light emitting control module 160; the light emitting control module 160 includes a fifth transistor T5 and a sixth transistor T6; the fifth transistor T5 is connected between the first power line VDD and the second terminal d of the driving module 110; the sixth transistor T6 is connected between the first terminal of the driving module 110 and a first terminal of the light emitting module 170; a control electrode of the sixth transistor T6 is connected to a fourth control line EM0 or a fifth control line EM1;

as shown in FIG. 11 or FIG. 12, the fourth control line EM0 is reused as a sixth control line EM01;

as shown in FIG. 13 or FIG. 14, the fifth control line EM1 is reused as a seventh control line EM11.

In this way, the number of signal lines can be reduced, the space occupied by the signal lines is reduced, and it is convenient to improve the pixel density of a display panel formed by the pixel circuit.

In one embodiment, referring to FIG. 11, FIG. 12, FIG. 13 or FIG. 14, the pixel circuit further includes a threshold compensation module 140; a control terminal of the threshold compensation module 140 is connected to a first control line EMB1, and the first control line EMB1 is reused as an eighth control line EMB11. This arrangement can further reduce the number of signal lines, reduce the space occupied by the signal lines, and facilitate improving the pixel density of a display panel formed by the pixel circuit.

Based on the some embodiments, control signals on some control lines are described below, but are not intended as limitations on the present application.

In one embodiment, referring to FIG. 13 or FIG. 14, a control electrode of the fifth transistor T5 is connected to a third control line EM2; a time period when a third control signal on the third control line EM2 is at an active level partially overlaps with a time period when a first control signal on the first control line EMB1 is at an active level, and an overlapping duration is less than or equal to one line time; the active level of the third control signal on the third control line EM2, relative to an active level of a fifth control signal on the fifth control line EM1, is delayed by one line time.

In one embodiment, the overlapping duration between the time period when the third control signal on the third control line EM2 is at an active level and the time period when the first control signal on the first control line EMB1 is at an active level being less than or equal to one line time makes the duration for which the third control signal controls the fifth transistor T5 and the first control signal controls an eighth transistor T8 to be simultaneously turned on less than or equal to one line time, thereby making the time for forming a current loop between the first power line VDD, the fifth transistor T5, the driving module 110 (the first transistor T1), the second reset module 190 and the first reset module 180 as shown in FIG. 13 short, or making the time for forming a current loop between the first power line VDD, the fifth transistor T5, the driving module 110 (the first transistor T1), the second reset module 190 and the first reset module 180 as shown in FIG. 14 short, which can reduce power consumption waste.

In another embodiment, in one embodiment, referring to FIG. 11 or FIG. 12, a control electrode of the fifth transistor T5 is connected to the second control line EMB2, and an active level of a second control signal on the second control line EMB2, relative to an active level of a first control signal on the first control line EMB1, is delayed by one line time.

Exemplarily, the display panel corresponding to the pixel circuit further includes a plurality of cascadedly connected second shift registers, a plurality of pixel circuits in the display panel are arranged in an array, the second control line EMB2 and the first control line EMB1 extend along a row direction, one second control line EMB2 is correspondingly connected to one row of pixel circuits, and one first control line EMB1 is correspondingly connected to one row of pixel circuits. For example, an m-th stage second shift register is connected to the first control line EMB1 corresponding to an m-th row of pixel circuits, and is connected to the second control line EMB2 corresponding to an (m-1)-th row of pixel circuits, or, the m-th stage second shift register is connected to the first control line EMB1 corresponding to an (m+1)-th row of pixel circuits, and is connected to the second control line EMB2 corresponding to the m-th row of pixel circuits. This enables the second shift registers to be shared, thereby reducing the number of shift registers, which is beneficial to achieving a narrow bezel. And m is an integer greater than 1.

In one embodiment, a turn-on duration of the fifth transistor T5 in the reset stage, controlled by the third control signal, is less than or equal to one line time;

or, a turn-on duration of the second reset module 190 in the reset stage, controlled by the first control signal, is less than or equal to one line time.

In this way, the duration for which the fifth transistor T5 and the second reset module 190 are simultaneously turned on can be made less than or equal to one line time, making the time for forming a current loop between the first power line VDD, the fifth transistor T5, the driving module 110 (the first transistor T1), the second reset module 190 and the first reset module 180 as shown in FIG. 13 short, or making the time for forming a current loop between the first power line VDD, the fifth transistor T5, the driving module 110 (the first transistor T1), the second reset module 190 and the first reset module 180 as shown in FIG. 14 short, which can reduce power consumption waste.

In one embodiment, referring to FIG. 11, FIG. 12, FIG. 13 or FIG. 14, the first reset module 180 includes a seventh transistor T7, and a type of the seventh transistor T7 is different from a type of the sixth transistor T6. In this way, when the seventh transistor T7 and the sixth transistor T6 share a same control line, the seventh transistor T7 and the sixth transistor T6 can be prevented from turning on simultaneously, thereby ensuring that when the seventh transistor T7 resets the first terminal of the light emitting module 170, the sixth transistor T6 will not turn on. This ensures that when the sixth transistor T6 is turned on and transmits the driving current, the seventh transistor T7 will not transmit the first reset voltage to the first terminal of the light emitting module 170.

Based on the some embodiments, in one embodiment, referring to FIG. 11 to FIG. 14, a control terminal of the data writing module 130 is connected to the scan line Scan;

when a refresh frequency of a display panel corresponding to the pixel circuit is less than a preset frequency, a frequency of an active level of a fourth control signal on the fourth control line EM0 is greater than a frequency of an active level of a scan signal on the scan line Scan;

a frequency of an active level of a fifth control signal on the fifth control line EM1 is greater than a frequency of an active level of a scan signal on the scan line Scan;

a frequency of an active level of a scan signal on the scan line Scan is the same as a frequency of an active level of a first control signal on the first control line EMB1;

when a refresh frequency of the display panel is greater than or equal to a preset frequency, a frequency of an active level of a fourth control signal on the fourth control line EM0, a frequency of an active level of a scan signal on the scan line Scan and a frequency of an active level of a first control signal on the first control line EMB1 are all the same.

And, for example, the preset frequency is any value from 10Hz-120Hz, for example, the preset frequency can be 60Hz, can also be 30Hz, or can also be 120Hz, which this embodiment does not limit.

In one embodiment, when the refresh frequency of the display panel formed by the pixel circuit is less than the preset frequency, that is, when the display panel is applied to low-frequency refresh, by setting the frequency of the active level of the fourth control signal to be greater than the frequency of the active level of the scan signal, and the frequency of the active level of the fifth control signal to be greater than the frequency of the active level of the scan signal, the frequency at which the fourth control signal or the fifth control signal controls the first reset module 180 to turn on can be made high, achieving high-frequency reset of the first terminal of the light emitting module 170, that is, high-frequency clearing of a residual charge at the first terminal of the light emitting module 170, thereby avoiding the problem of driving current fluctuation caused by the driving module 110 generating a driving current for a long time when the refresh frequency is low, thus avoiding low-frequency flicker.

The frequency of the active level of a scan signal on the scan line Scan being the same as the frequency of the active level of a first control signal on the first control line EMB1 allows the frequency of the active level of a control signal corresponding to a transistor that does not require high-frequency startup to be lower, thereby reducing power consumption.

When the refresh frequency of the display panel is greater than or equal to the preset frequency, that is, when the display panel is applied to high-frequency refresh, high-frequency reset of the first terminal of the light emitting module 170 can be ensured, then the frequency of the active level of the fourth control signal on the fourth control line EM0, the frequency of the active level of the scan signal on the scan line Scan and the frequency of the active level of the first control signal on the first control line EMB1 can all be set to be the same, which is beneficial to reducing power consumption.

In one embodiment, when the refresh frequency of the display panel is less than the preset frequency, one display frame of a display panel corresponding to the pixel circuit includes a writing frame and a holding frame; the reset stage includes a first reset sub-stage located in the writing frame and a second reset sub-stage located in the holding frame; the first reset module 180 is configured to, in the first reset sub-stage and the second reset sub-stage, turn on in response to the fourth control signal or the fifth control signal to transmit a first reset voltage on the first reset signal line Vref1 to the first terminal of the light emitting module 170. In this way, the reset frequency of the first terminal of the light emitting module 170 is made high, for high-frequency reset of the first terminal of the light emitting module 170, thereby avoiding the problem of driving current fluctuation caused by the driving module 110 generating a driving current for a long time when the refresh frequency is low, thus avoiding low-frequency flicker.

In one embodiment, referring to FIG. 11 or FIG. 13, the first reset module 180 includes a seventh transistor T7, a first electrode of the seventh transistor T7 is connected to the first reset signal line Vref1, a second electrode of the seventh transistor T7 is connected to the first terminal of the light emitting module 170, and a control electrode of the seventh transistor T7 is connected to the sixth control line EM01 or the seventh control line EM11.

In one embodiment, the first electrode of the seventh transistor T7 is a source electrode, and the second electrode of the seventh transistor T7 is a drain electrode; or, the first electrode of the seventh transistor T7 is a drain electrode, and the second electrode of the seventh transistor T7 is a source electrode, which this embodiment does not limit. When the seventh transistor T7 is turned on, the seventh transistor T7 may transmit the first reset voltage on the first reset signal line Vref1 to the first terminal of the light emitting module 170, to reset the first terminal of the light emitting module 170.

In one embodiment, referring to FIG. 11 or FIG. 13, the second reset module 190 includes an eighth transistor T8, the eighth transistor T8 is connected between the first terminal of the light emitting module 170 and the second terminal of the driving module 110, and a control electrode of the eighth transistor T8 is connected to the eighth control line EMB11.

In one embodiment, the first electrode of the eighth transistor T8 is a source electrode, and the second electrode of the eighth transistor T8 is a drain electrode; or, the first electrode of the eighth transistor T8 is a drain electrode, and the second electrode of the eighth transistor T8 is a source electrode, which this embodiment does not limit. When the eighth transistor T8 is turned on, the eighth transistor T8 may transmit the first reset voltage at the first terminal of the light emitting module 170 to the first terminal s of the driving module 110, facilitating turning on of the driving module 110. And when the eighth transistor T8 and the seventh transistor T7 turn on, the first terminal of the coupling module 120 is facilitated to discharge through the threshold compensation module 140, the driving module 110, the eighth transistor T8 and the seventh transistor T7, thereby performing threshold compensation on the driving module 110.

In one embodiment, referring to FIG. 11 or FIG. 13, the eighth transistor T8 is an N-type transistor. In this way, the leakage current at the first terminal s of the driving module 110 can be reduced, facilitating maintaining the stability of the driving current generated by the driving module 110.

In one embodiment, referring to FIG. 12 or FIG. 14, the first reset module 180 includes a seventh transistor T7, a first electrode of the seventh transistor T7 is connected to the first reset signal line Vref1, a second electrode of the seventh transistor T7 is connected to the first terminal of the light emitting module 170, and a control electrode of the seventh transistor T7 is connected to the sixth control line EM01 or the seventh control line EM11. The working principle of the seventh transistor T7 shown in FIG. 12 is the same as that of the seventh transistor T7 shown in FIG. 11, and the working principle of the seventh transistor T7 shown in FIG. 14 is the same as that of the seventh transistor T7 shown in FIG. 13, which are not repeated here.

In one embodiment, referring to FIG. 12 or FIG. 14, the second reset module 190 includes an eighth transistor T8, the eighth transistor T8 is connected between the second reset signal line Vref2 and the first terminal s of the driving module 110, and a control electrode of the eighth transistor T8 is connected to the eighth control line EMB11.

In one embodiment, the first electrode of the eighth transistor T8 is a source electrode, and the second electrode of the eighth transistor T8 is a drain electrode; or, the first electrode of the eighth transistor T8 is a drain electrode, and the second electrode of the eighth transistor T8 is a source electrode, which this embodiment does not limit. When the eighth transistor T8 is turned on, the eighth transistor T8 may transmit the second reset voltage on the second reset signal line Vref2 to the first terminal s of the driving module 110, facilitating turning on of the driving module 110. And when the eighth transistor T8 is turned on, the first terminal of the coupling module 120 is facilitated to discharge through the threshold compensation module 140, the driving module 110 and the eighth transistor T8, thereby performing threshold compensation on the driving module 110.

In one embodiment, referring to FIG. 12 or FIG. 14, the eighth transistor T8 is an N-type transistor. In this way, the leakage current at the first terminal s of the driving module 110 can be reduced, facilitating maintaining the stability of the driving current generated by the driving module 110.

Possible working processes of the pixel circuit are described below, but are not intended as limitations on the present application.

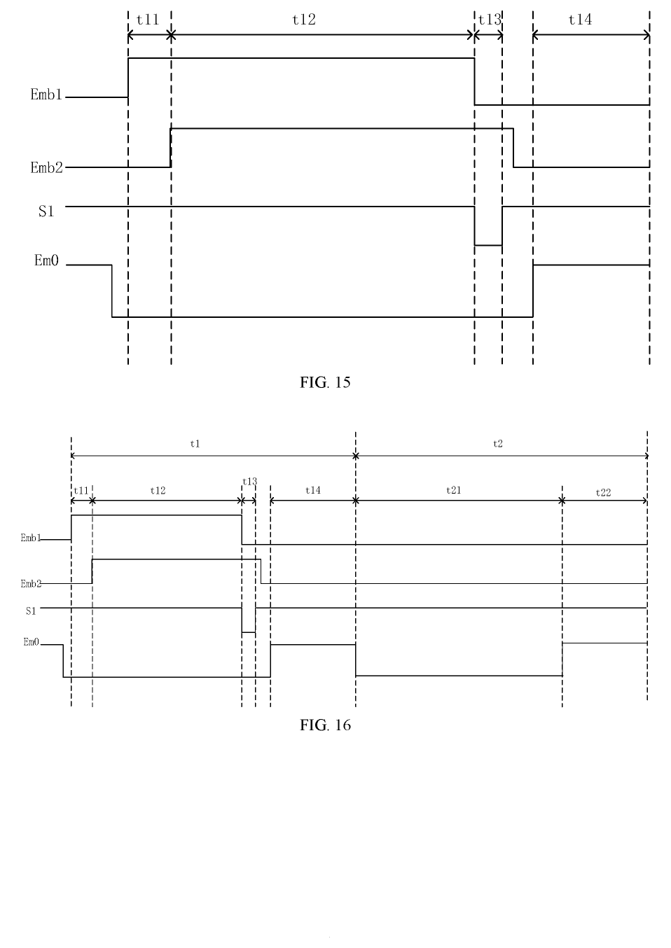

In one embodiment, FIG. 15 is a timing diagram of a pixel circuit provided by an embodiment of the present application, FIG. 15 is a timing diagram corresponding to FIG. 11 and FIG. 12. Referring to FIG. 11 and FIG. 15, when a display panel formed by the pixel circuit is applied to high-frequency refresh, the driving process of the pixel circuit includes the following several stages.

In a reset stage t11, a first control signal Emb1 on the first control line EMB1 is at a high level, a second control signal Emb2 on the second control line EMB2 is at a low level, a fourth control signal Em0 on the fourth control line EM0 is at a low level, the seventh transistor T7, the eighth transistor T8, the second transistor T2 and the fifth transistor T5 turn on, the seventh transistor T7 transmits a first reset voltage Vr1 on the first reset signal line Vref1 to a first electrode a of the organic light emitting diode D1, to reset the first electrode a of the organic light emitting diode D1, and Va=Vr1. The eighth transistor T8 transmits the first reset voltage to the first electrode s of the first transistor T1, and Vs=Vr1. A first power voltage Vdd on the first power line VDD charges the first electrode of the first capacitor C1 through the fifth transistor T5 and the second transistor T2, and a voltage Vg at the control electrode g of the first transistor T1 is high, and Vg>Vs+Vth, and Vth is the threshold voltage of the first transistor T1, thereby causing the first transistor T1 to turn on.

In a compensation stage t12, the first control signal Emb1 on the first control line EMB1 is at a high level, the second control signal Emb2 on the second control line EMB2 is at a high level, the fourth control signal Em0 on the fourth control line EM0 is at a low level, the first transistor T1, the second transistor T2, the third transistor T3, the seventh transistor T7 and the eighth transistor T8 turn on, the seventh transistor T7 transmits the first reset voltage Vr1 on the first reset signal line Vref1 to the first electrode a of the organic light emitting diode D1, and Va=Vr1. The eighth transistor T8 transmits the first reset voltage to the first electrode s of the first transistor T1, and the third transistor T3 transmits the first reset voltage to a second electrode n of the first capacitor C1, and Vn=Vr1. The voltage at the second electrode n of the first capacitor C1 is fixed, and the first electrode of the first capacitor C1 discharges to the first reset signal line Vref1 through the second transistor T2, the first transistor T1, the eighth transistor T8 and the seventh transistor T7, until the voltage at the first electrode of the first capacitor C1 (i.e., the control electrode g of the first transistor T1) is Vr1+Vth, and the first transistor T1 is turned off (i.e., is turned off), achieving threshold compensation.

In a data writing stage t13, the second control signal Emb2 on the second control line EMB2 is at a high level, the fourth control signal Em0 on the fourth control line EM0 is at a low level, a scan signal S1 on the scan line Scan is at a low level, the seventh transistor T7 is turned on, the fourth transistor T4 and the third transistor T3 turn on, the seventh transistor T7 transmits the first reset voltage Vr1 on the first reset signal line Vref1 to the first electrode a of the organic light emitting diode D1, maintaining the voltage of a second electrode of the second capacitor C2, the fourth transistor T4 transmits the data voltage Vdara on the data line Data to the first electrode s of the first transistor T1, and the third transistor T3 transmits the data voltage Vdara to a first electrode of the second capacitor C2, and Vn=Vdara, the voltage difference across the first capacitor C1 remains unchanged, the voltage difference across the first capacitor C1 is Vth, and the voltage at the first electrode of the first capacitor C1 is Vg=Vdata+Vth, achieving writing of the data voltage.

In a light emitting stage t14, the second control signal Emb2 on the second control line EMB2 is at a low level, the fourth control signal Em0 on the fourth control line EM0 is at a high level, the fifth transistor T5 and the sixth transistor T6 turn on, and the voltage at the first electrode a of the organic light emitting diode D1 is Va=Vss+Voled. In one embodiment, Vss is a second power voltage on the second power line VSS, and Voled is a voltage across the organic light emitting diode D1. The voltage difference across the second capacitor C2 remains unchanged, and the voltage difference across the first capacitor C1 remains unchanged, and Vg=Vdata+Vth+Vss+Voled-Vr1. The sixth transistor T6 is turned on, and the voltage at the first electrode s of the first transistor T1 is Vs=Vss+Voled. Then a voltage difference Vgs between the control electrode g of the first transistor T1 and the first electrode s of the first transistor T1 is Vgs=Vdata+Vth-Vr1. The first power line VDD, the fifth transistor T5, the first transistor T1, the sixth transistor T6, the organic light emitting diode D1 and the second power line VSS may form a current loop, and the first transistor T1 generates a driving current, and the organic light emitting diode D1 emits light in response to the driving current. The driving current is I, then I=1/2*μ*Cox*W/L*(Vgs-Vth) ²=1/2*μ*Cox*W/L*(Vdata-Vr1) ², and, μ is the electron mobility of the first transistor T1, Cox is the channel capacitance per unit area of the first transistor T1, W is the channel width of the first transistor T1, L is the channel length of the first transistor T1, and Vth is the threshold voltage of the first transistor T1. In this way, the driving current is made to be related only to the data voltage and the first reset voltage, avoiding the problem of driving current fluctuation caused by a threshold voltage offset of the first transistor T1, and being able to avoid the fluctuation of the driving current caused by a voltage drop of the first power line VDD and the second power line VSS, and avoiding the influence on the driving current from a change in voltage across the organic light emitting diode D1 caused by aging, thereby being able to ensure the stability of the driving current, in turn ensuring that the organic light emitting diode D1 can emit light stably, and being able to improve the display effect of a display panel formed by the pixel circuit.

And, the driving current is related only to the data voltage and the first reset voltage, and is independent of the capacitance value of a capacitor, that is, there is no capacitor influence, and the driving current can be large, facilitating the implementation of high-brightness technology.

Referring to FIG. 12 and FIG. 15, when a display panel formed by the pixel circuit is applied to high-frequency refresh, the driving process of the pixel circuit includes the following several stages.

In a reset stage t11, a first control signal Emb1 on the first control line EMB1 is at a high level, a second control signal Emb2 on the second control line EMB2 is at a low level, a fourth control signal Em0 on the fourth control line EM0 is at a low level, the seventh transistor T7, the eighth transistor T8, the second transistor T2 and the fifth transistor T5 turn on, the seventh transistor T7 transmits a first reset voltage Vr1 on the first reset signal line Vref1 to a first electrode a of the organic light emitting diode D1, to reset the first electrode a of the organic light emitting diode D1, and Va=Vr1. The eighth transistor T8 transmits a second reset voltage Vr2 on the second reset signal line Vref2 to the first electrode s of the first transistor T1, and Vs=Vr2. A first power voltage Vdd on the first power line VDD charges the first electrode of the first capacitor C1 through the fifth transistor T5 and the second transistor T2, and a voltage Vg at the control electrode g of the first transistor T1 is high, and Vg>Vs+Vth, and Vth is the threshold voltage of the first transistor T1, thereby causing the first transistor T1 to turn on.

In a compensation stage t12, the first control signal Emb1 on the first control line EMB1 is at a high level, the second control signal Emb2 on the second control line EMB2 is at a high level, the fourth control signal Em0 on the fourth control line EM0 is at a low level, the first transistor T1, the second transistor T2, the third transistor T3, the seventh transistor T7 and the eighth transistor T8 turn on, the seventh transistor T7 transmits the first reset voltage Vr1 on the first reset signal line Vref1 to the first electrode a of the organic light emitting diode D1, and Va=Vr1. The eighth transistor T8 transmits the second reset voltage Vr2 to the first electrode s of the first transistor T1, and the third transistor T3 transmits the first reset voltage to a second electrode n of the first capacitor C1, and Vn=Vr2. The voltage at the second electrode n of the first capacitor C1 is fixed, and the first electrode of the first capacitor C1 discharges to the second reset signal line Vref2 through the second transistor T2, the first transistor T1 and the eighth transistor T8, until the voltage at the first electrode of the first capacitor C1 (i.e., the control electrode g of the first transistor T1) is Vr2+Vth, and the first transistor T1 is turned off (i.e., is turned off), achieving threshold compensation.

In a data writing stage t13, the second control signal Emb2 on the second control line EMB2 is at a high level, the fourth control signal Em0 on the fourth control line EM0 is at a low level, a scan signal S1 on the scan line Scan is at a low level, the seventh transistor T7 is turned on, the fourth transistor T4 and the third transistor T3 turn on, the seventh transistor T7 transmits the first reset voltage Vr1 on the first reset signal line Vref1 to the first electrode a of the organic light emitting diode D1, and Va=Vr1, maintaining the voltage of a second electrode of the second capacitor C2, the fourth transistor T4 transmits the data voltage Vdara on the data line Data to the first electrode s of the first transistor T1, and the third transistor T3 transmits the data voltage Vdara to a first electrode of the second capacitor C2, and Vn=Vdara, the voltage difference across the first capacitor C1 remains unchanged, the voltage difference across the first capacitor C1 is Vth, and the voltage at the first electrode of the first capacitor C1 is Vg=Vdata+Vth, achieving writing of the data voltage.

In a light emitting stage t14, the second control signal Emb2 on the second control line EMB2 is at a low level, the fourth control signal Em0 on the fourth control line EM0 is at a high level, the fifth transistor T5 and the sixth transistor T6 turn on, and the voltage at the first electrode a of the organic light emitting diode D1 is Va=Vss+Voled. In one embodiment, Vss is a second power voltage on the second power line VSS, and Voled is a voltage across the organic light emitting diode D1. The voltage difference across the second capacitor C2 remains unchanged, and the voltage difference across the first capacitor C1 remains unchanged, and Vg=Vdata+Vth+Vss+Voled-Vr1. The sixth transistor T6 is turned on, and the voltage at the first electrode s of the first transistor T1 is Vs=Vss+Voled. Then a voltage difference Vgs between the control electrode of the first transistor T1 and the first electrode s of the first transistor T1 is Vgs=Vdata+Vth-Vr1. The first power line VDD, the fifth transistor T5, the first transistor T1, the sixth transistor T6, the organic light emitting diode D1 and the second power line VSS may form a current loop, and the first transistor T1 generates a driving current, and the organic light emitting diode D1 emits light in response to the driving current. The driving current is I, then I=1/2*μ*Cox*W/L*(Vgs-Vth)²=1/2*μ*Cox*W/L*(Vdata-Vr1)².

In another embodiment, FIG. 16 is a timing diagram of another pixel circuit provided by an embodiment of the present application. Referring to FIG. 11 and FIG. 16, when a display panel formed by the pixel circuit is applied to low-frequency refresh, one display frame of the display panel includes a writing frame t1 and a holding frame t2. In the writing frame t1, the driving process of the pixel circuit includes a first reset sub-stage t11, a compensation stage t12, a data writing stage t13 and a first light emitting sub-stage t14. In the writing frame t1, the driving process of the pixel circuit is the same as the driving process of the timing diagram corresponding to FIG. 15, and is not repeated here. In the holding frame t2, the driving process of the pixel circuit includes a second reset sub-stage t21 and a second light emitting sub-stage t22.

In the second reset sub-stage t21, a fourth control signal Em0 on the fourth control line EM0 is at a low level, and the seventh transistor T7 is turned on. The seventh transistor T7 transmits a first reset voltage Vr1 on the first reset signal line Vref1 to a first electrode a of the organic light emitting diode D1, to reset the first electrode a of the organic light emitting diode D1.

In the second light emitting sub-stage t22, a second control signal Emb2 on the second control line EMB2 is at a low level, and the fourth control signal Em0 on the fourth control line EM0 is at a high level. The fifth transistor T5 and the sixth transistor T6 turn on, and the first power line VDD, the fifth transistor T5, the first transistor T1, the sixth transistor T6, the organic light emitting diode D1 and the second power line VSS may form a current loop, and the first transistor T1 generates a driving current, and the organic light emitting diode D1 emits light in response to the driving current.

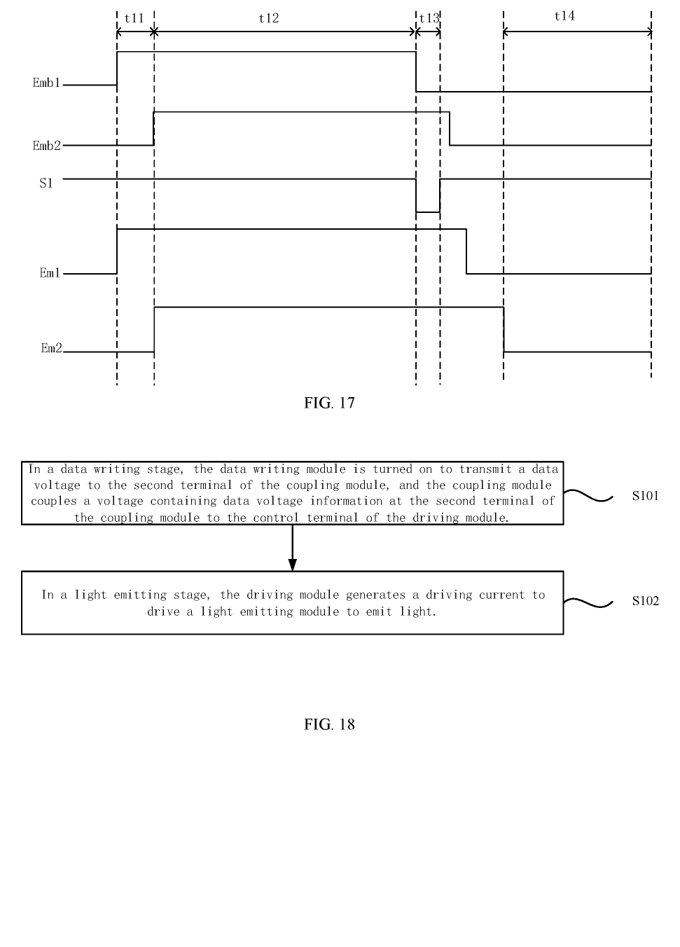

In yet another embodiment, FIG. 17 is a timing diagram of yet another pixel circuit provided by an embodiment of the present application, FIG. 17 is a timing diagram corresponding to FIG. 13 and FIG. 14. Referring to FIG. 17, the driving process of the pixel circuit includes the following several stages. Referring to FIG. 13 and FIG. 17, when a display panel formed by the pixel circuit is applied to high-frequency refresh, the driving process of the pixel circuit includes the following several stages.

In a reset stage t11, a first control signal Emb1 on the first control line EMB1 is at a high level, a second control signal Emb2 on the second control line EMB2 is at a low level, a fifth control signal Em1 on the fifth control line EM1 is at a high level, and a third control signal Em2 on the third control line EM2 is at a low level. The seventh transistor T7, the eighth transistor T8, the second transistor T2 and the fifth transistor T5 turn on. The seventh transistor T7 transmits a first reset voltage Vr1 on the first reset signal line Vref1 to a first electrode a of the organic light emitting diode D1, to reset the first electrode a of the organic light emitting diode D1, and Va=Vr1. The eighth transistor T8 transmits the first reset voltage to the first electrode s of the first transistor T1, and Vs=Vr1. A first power voltage Vdd on the first power line VDD charges the first electrode of the first capacitor C1 through the fifth transistor T5 and the second transistor T2, and a voltage Vg at the control electrode g of the first transistor T1 is high, and Vg>Vs+Vth, and Vth is the threshold voltage of the first transistor T1, thereby causing the first transistor T1 to turn on.

In a compensation stage t12, the first control signal Emb1 on the first control line EMB1 is at a high level, the second control signal Emb2 on the second control line EMB2 is at a high level, and the fifth control signal Em1 on the fifth control line EM1 is at a high level. The first transistor T1, the second transistor T2, the third transistor T3, the seventh transistor T7 and the eighth transistor T8 turn on. The seventh transistor T7 transmits the first reset voltage Vr1 on the first reset signal line Vref1 to the first electrode a of the organic light emitting diode D1, and Va=Vr1. The eighth transistor T8 transmits the first reset voltage to the first electrode s of the first transistor T1, and the third transistor T3 transmits the first reset voltage to a second electrode n of the first capacitor C1, and Vn=Vr1. The voltage at the second electrode n of the first capacitor C1 is fixed, and the first electrode of the first capacitor C1 discharges to the first reset signal line Vref1 through the second transistor T2, the first transistor T1, the eighth transistor T8 and the seventh transistor T7, until the voltage at the first electrode of the first capacitor C1 (i.e., the control electrode g of the first transistor T1) is Vr1+Vth, and the first transistor T1 is turned off (i.e., is turned off), achieving threshold compensation.

In a data writing stage t13, the second control signal Emb2 on the second control line EMB2 is at a high level, the fifth control signal Em1 on the fifth control line EM1 is at a high level, and a scan signal S1 on the scan line Scan is at a low level. The seventh transistor T7 is turned on, and the fourth transistor T4 and the third transistor T3 turn on. The seventh transistor T7 transmits the first reset voltage Vr1 on the first reset signal line Vref1 to the first electrode a of the organic light emitting diode D1, maintaining the voltage of a second electrode of the second capacitor C2. The fourth transistor T4 transmits the data voltage Vdata on the data line Data to the first electrode s of the first transistor T1, and the third transistor T3 transmits the data voltage Vdata to a first electrode of the second capacitor C2, and Vn=Vdata. The voltage difference across the first capacitor C1 remains unchanged, and the voltage difference across the first capacitor C1 is Vth, and the voltage at the first electrode of the first capacitor C1 is Vg=Vdata+Vth, achieving writing of the data voltage.

In a light emitting stage t14, the fifth control signal Em1 on the fifth control line EM1 is at a low level, the third control signal Em2 on the third control line EM2 is at a low level, and the fifth transistor T5 and the sixth transistor T6 turn on. The voltage at the first electrode a of the organic light emitting diode D1 is Va=Vss+Voled. And Vss is a second power voltage on the second power line VSS, and Voled is a voltage across the organic light emitting diode D1. The voltage difference across the second capacitor C2 remains unchanged, and the voltage difference across the first capacitor C1 remains unchanged, and Vg=Vdata+Vth+Vss+Voled-Vr1. The sixth transistor T6 is turned on, and the voltage at the first electrode s of the first transistor T1 is Vs=Vss+Voled. Then a voltage difference Vgs between the control electrode of the first transistor T1 and the first electrode s of the first transistor T1 is Vgs=Vdata+Vth-Vr1. The first power line VDD, the fifth transistor T5, the first transistor T1, the sixth transistor T6, the organic light emitting diode D1 and the second power line VSS may form a current loop, and the first transistor T1 generates a driving current, and the organic light emitting diode D1 emits light in response to the driving current. The driving current is I, then I=1/2*μ*Cox*W/L*(Vgs-Vth) ²=1/2*μ*Cox*W/L*(Vdata-Vr1)², and, μ is the electron mobility of the first transistor T1, Cox is the channel capacitance per unit area of the first transistor T1, W is the channel width of the first transistor T1, L is the channel length of the first transistor T1, and Vth is the threshold voltage of the first transistor T1. In this way, the driving current is made to be related only to the data voltage and the first reset voltage, avoiding the problem of driving current fluctuation caused by a threshold voltage offset of the first transistor T1, and being able to avoid the fluctuation of the driving current caused by a voltage drop of the first power line VDD and the second power line VSS, and avoiding the influence on the driving current from a change in voltage across the organic light emitting diode D1 caused by aging, thereby being able to ensure the stability of the driving current, in turn ensuring that the organic light emitting diode D1 can emit light stably, and being able to improve the display effect of a display panel formed by the pixel circuit.

The driving process corresponding to FIG. 14 is the same as the driving process corresponding to FIG. 13, and the voltage changes at each node in the driving process corresponding to FIG. 14 are the same as the voltage changes at corresponding nodes in the driving process corresponding to FIG. 12, which are not repeated here.

In summary, as shown in FIG. 15 to FIG. 17, the pixel circuit of this embodiment only requires three groups of control signals to achieve the driving process of the pixel circuit, making the number of shift registers required by the pixel circuit small, facilitating the implementation of a narrow bezel.

An embodiment of the present application also provides a driving method for a pixel circuit, and the pixel circuit is the pixel circuit provided by any embodiment of the present application. As shown in FIG. 1, the pixel circuit includes: a driving module 110, a coupling module 120 and a data writing module 130; a first terminal of the coupling module 120 is connected to a control terminal of the driving module 110; a first terminal of the data writing module 130 is connected to a first terminal of the driving module 110, and the first terminal of the data writing module 130 is also connected to a second terminal of the coupling module 120.

FIG. 18 is a flowchart of a driving method for a pixel circuit provided by an embodiment of the present application. Referring to FIG. 18, the driving method for a pixel circuit includes:

S101, in a data writing stage, the data writing module is turned on to transmit a data voltage to the second terminal of the coupling module, and the coupling module couples a voltage containing data voltage information at the second terminal of the coupling module to the control terminal of the driving module.

In one embodiment, the data writing module 130 may, when turned on, transmit the data voltage to the second terminal of the coupling module 120. The coupling module 120 may couple the voltage containing data voltage information at the second terminal of the coupling module 120 to the first terminal of the coupling module 120, i.e., couple to the control terminal of the driving module 110, thereby achieving writing of the data voltage. In this way, direct writing of the data voltage is achieved without passing through the driving module 110, which can effectively reduce the required time for data writing, thereby facilitating application to a display panel with a higher refresh frequency. And, when writing data, passing through the driving module 110 and a threshold compensation module is not necessary, the data writing stage and a threshold compensation stage can be separated, and when the refresh frequency of the display panel is high, a longer threshold compensation time can still be set, thereby improving the threshold compensation effect, making the driving current generated by the driving module 110 independent of the threshold voltage of a transistor in the driving module 110, and the electrical characteristics of a transistor in the driving module 110 will not affect the grayscale brightness difference of the display device, that is, under a same grayscale, driving currents generated by different driving modules 110 tend to be consistent, thereby improving the display uniformity of the display panel corresponding to the pixel circuit, in turn improving the display effect of the display panel, and improving the usage performance of the display panel.

S102, in a light emitting stage, the driving module generates a driving current to drive a light emitting module to emit light.

In one embodiment, the pixel circuit may also include a light emitting module, the driving module 110 is connected to the light emitting module, the driving module 110 may generate a driving current, and the light emitting module emits light in response to the driving current.

Based on the some embodiments, in one embodiment, referring to FIG. 3, the pixel circuit further includes: a threshold compensation module 140, the threshold compensation module 140 is connected between the control terminal of the driving module 110 and a second terminal of the driving module 110. In one embodiment, referring to FIG. 3, the pixel circuit further includes: a switching module 150, a first terminal of the switching module 150 is connected to the first terminal of the data writing module 130, a second terminal of the switching module 150 is connected to the second terminal of the coupling module 120, and a control terminal of the switching module 150 is connected to the scan line Scan or the second control line EMB2.

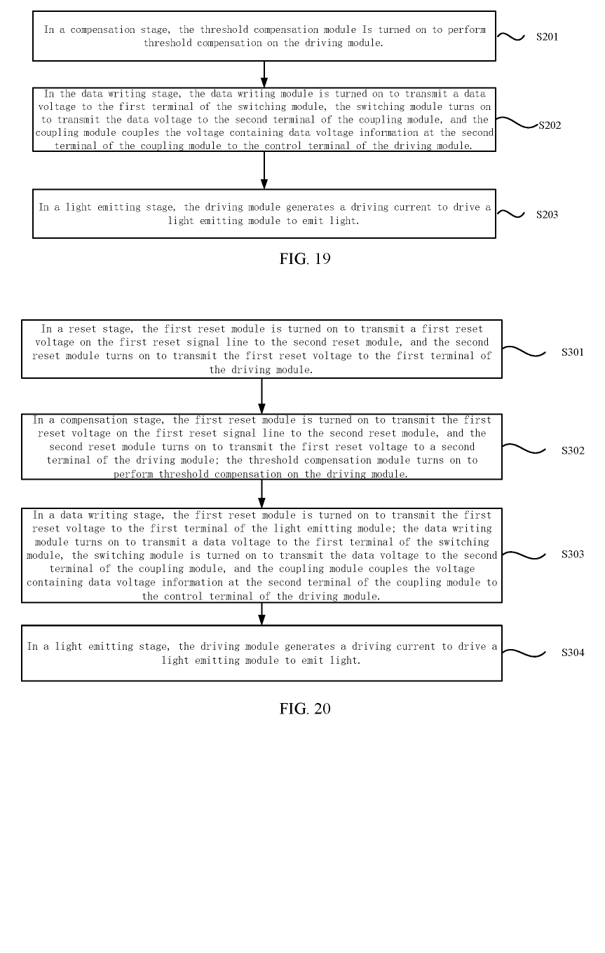

FIG. 19 is a flowchart of another driving method for a pixel circuit provided by an embodiment of the present application. In one embodiment, referring to FIG. 19, the driving method for a pixel circuit includes:

S201, in a compensation stage, the threshold compensation module is turned on to perform threshold compensation on the driving module.

In one embodiment, in the compensation stage, the threshold compensation module 140 is turned on to perform threshold compensation on the driving module 110. Thereby, the compensation stage and a data writing stage are separated, and the duration of the compensation stage can be controlled separately, and when the refresh frequency of the display panel corresponding to the pixel circuit is high, a longer compensation time can also be set, thereby ensuring the threshold compensation effect, making the driving current generated by the driving module 110 independent of the threshold voltage of a transistor in the driving module 110, and the electrical characteristics of a transistor in the driving module 110 will not affect the grayscale brightness difference of the display device, that is, under a same grayscale, driving currents generated by different driving modules 110 tend to be consistent, thereby improving the display uniformity of the display panel corresponding to the pixel circuit.

S202, in the data writing stage, the data writing module is turned on to transmit a data voltage to the first terminal of the switching module, the switching module is turned on to transmit the data voltage to the second terminal of the coupling module, and the coupling module couples the voltage containing data voltage information at the second terminal of the coupling module to the control terminal of the driving module.

In one embodiment, in the data writing stage, a scan signal on the scan line Scan controls the data writing module 130 to turn on, and a scan signal on the scan line Scan or a second control signal on the second control line EMB2 controls the switching module 150 to turn on, and the data writing module 130 transmits the data voltage on the data line Data to the first terminal of the switching module 150 (i.e., the first terminal s of the driving module 110), and the switching module 150 transmits the data voltage to the second terminal n of the coupling module 120, facilitating the coupling module 120 to couple the voltage containing data voltage information at the second terminal of the coupling module 120 to the control terminal g of the driving module 110.

S203, in a light emitting stage, the driving module generates a driving current to drive a light emitting module to emit light.

Based on the some embodiments, in one embodiment, referring to FIG. 9, the pixel circuit further includes: a light emitting module 170, a first reset module 180 and a second reset module 190, a first terminal of the first reset module 180 is connected to a first reset signal line Vref1, a second terminal of the first reset module 180 is connected to a first terminal of the light emitting module 170; a control terminal of the first reset module 180 is connected to a sixth control line EM01 or a seventh control line EM11; the second reset module 190 is connected between the second terminal of the first reset module 180 and the first terminal s of the driving module 110, and a control terminal of the second reset module 190 is connected to an eighth control line EMB11.

FIG. 20 is a flowchart of yet another driving method for a pixel circuit provided by an embodiment of the present application. In one embodiment, referring to FIG. 20, the driving method for a pixel circuit includes:

S301, in a reset stage, the first reset module is turned on to transmit a first reset voltage on the first reset signal line to the second reset module, and the second reset module is turned on to transmit the first reset voltage to the first terminal of the driving module.

In one embodiment, in the reset stage, the first reset module 180 is turned on, and the first reset module 180 transmits the first reset voltage on the first reset signal line Vref1 to the first terminal of the light emitting module 170, to reset the first terminal of the light emitting module 170. And, the second reset module 190 is turned on, and the second reset module 190 may transmit the first reset voltage at the first terminal of the light emitting module 170 to the first terminal s of the driving module 110, to reset the first terminal s of the driving module 110, and make the voltage at the first terminal s of the driving module 110 small, facilitating turning on of the driving module 110.

S302, in a compensation stage, the first reset module is turned on to transmit the first reset voltage on the first reset signal line to the second reset module, and the second reset module is turned on to transmit the first reset voltage to a second terminal of the driving module; the threshold compensation module is turned on to perform threshold compensation on the driving module.

In one embodiment, in the compensation stage, the driving module 110, the threshold compensation module 140, the first reset module 180 and the second reset module 190 turn on, and the first terminal of the coupling module 120 discharges through the threshold compensation module 140, the driving module 110, the second reset module 190 and the first reset module 180, until the voltage at the control terminal g of the driving module 110 is the sum of the first reset voltage and the threshold voltage of a transistor in the driving module 110, and the driving module 110 is turned off, thereby making the voltage at the control terminal of the driving module 110 a voltage related to the threshold voltage of a transistor in the driving module 110, and achieving threshold compensation.

S303, in a data writing stage, the first reset module is turned on to transmit the first reset voltage to the first terminal of the light emitting module; the data writing module is turned on to transmit a data voltage to the first terminal of the switching module, the switching module is turned on to transmit the data voltage to the second terminal of the coupling module, and the coupling module couples the voltage containing data voltage information at the second terminal of the coupling module to the control terminal of the driving module.

In one embodiment, the first reset module 180 turning on in the data writing stage can maintain the voltage at the first terminal of the light emitting module 170. This facilitates, after the switching module 150 transmits the data voltage to the second terminal n of the coupling module 120, the coupling module 120 to couple the voltage containing data voltage information at the second terminal of the coupling module 120 to the control terminal g of the driving module 110, thereby achieving writing of the data voltage.

S304, in a light emitting stage, the driving module generates a driving current to drive a light emitting module to emit light.

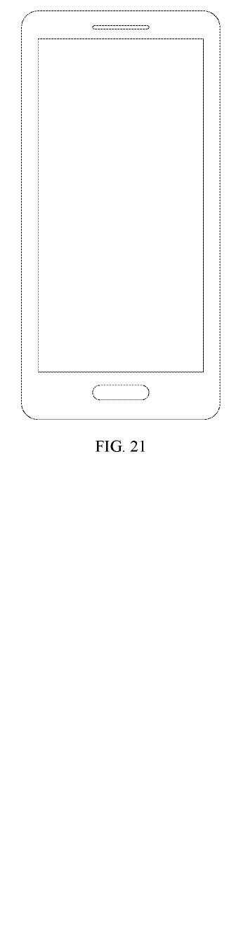

An embodiment of the present application also provides a display panel. FIG. 21 is a structural schematic diagram of a display panel provided by an embodiment of the present application. Referring to FIG. 21, the display panel includes the pixel circuit provided by any of the above embodiments. The display panel may be applied to a mobile phone, a tablet, a monitor, a smart watch, an MP3, an MP4 or other wearable device, etc. Because the display panel includes the pixel circuit provided by any embodiment of the present application, the display panel also has the same beneficial effects, which are not repeated here.

It should be understood that various forms of flows shown above may be used, with steps reordered, added or deleted. For example, the steps described in the present application may be performed in parallel, sequentially, or in different orders, as long as the desired results of the embodiments of the present application can be achieved, which is not limited herein.

The above specific embodiments do not constitute limitations on the protection scope of the present application. A person should understand that various modifications, combinations, sub-combinations and substitutions may be made according to design requirements and other factors. Any modifications, equivalent replacements and improvements made within the spirit and principles of the present application shall be included in the protection scope of the present application.

What is claimed is:

1. A pixel circuit, comprising:
a driving module;
a coupling module, wherein a first terminal of the coupling module is connected to a control terminal of the driving module; and
a data writing module, wherein a first terminal of the data writing module is connected to a first terminal of the driving module, the first terminal of the data writing module is further connected to a second terminal of the coupling module, the data writing module is configured to transmit a data voltage to the second terminal of the coupling module, and the coupling module is configured to couple a voltage containing data voltage information at the second terminal of the coupling module to the control terminal of the driving module.

2. The pixel circuit according to claim 1, wherein a control terminal of the data writing module is connected to a scan line, a second terminal of the data writing module is connected to a data line, and the data writing module is configured to, in a data writing stage, turn on in response to a scan signal on the scan line and transmit the data voltage on the data line to the second terminal of the coupling module;
the pixel circuit further comprising:
a threshold compensation module connected between the control terminal of the driving module and a second terminal of the driving module;
wherein a control terminal of the threshold compensation module is connected to a first control line; and
wherein a compensation stage is before the data writing stage.

3. The pixel circuit according to claim 2, further comprising:
a switching module, wherein a first terminal of the switching module is connected to the first terminal of the data writing module, a second terminal of the switching module is connected to the second terminal of the coupling module, and a control terminal of the switching module is connected to the scan line or a second control line;
wherein the data writing module is configured to, in the data writing stage, transmit the data voltage to the first terminal of the switching module, and the switching module is configured to transmit the data voltage to the second terminal of the coupling module.

4. The pixel circuit according to claim 3, wherein a waveform of an active level of a second control signal on the second control line is the same as a waveform of an active level of a first control signal on the first control line; and the active level of the second control signal on the second control line, relative to the active level of the first control signal on the first control line, is delayed by one line time.

5. The pixel circuit according to claim 3, wherein the driving module comprises a first transistor, a control electrode of the first transistor is connected to the first terminal of the coupling module, a first electrode of the first transistor is connected to the first terminal of the data writing module, and a second electrode of the first transistor is connected to the threshold compensation module;
the threshold compensation module comprises a second transistor, the second transistor is connected between the control terminal of the driving module and the second terminal of the driving module, and a control electrode of the second transistor is connected to the first control line;
the switching module comprises a third transistor, a first electrode of the third transistor is connected to the first terminal of the data writing module, a second electrode of the third transistor is connected to the second terminal of the coupling module, and a control electrode of the third transistor is connected to the scan line or the second control line;
the data writing module comprises a fourth transistor, a first electrode of the fourth transistor is connected to the first terminal of the driving module, a second electrode of the fourth transistor is connected to the data line, and a control electrode of the fourth transistor is connected to the scan line;
the coupling module comprises a first capacitor, a first electrode of the first capacitor is connected to the control terminal of the driving module, and a second electrode of the first capacitor is connected to the second terminal of the switching module;
the first transistor is an N-type transistor; and
the second transistor is an N-type transistor.

6. The pixel circuit according to claim 1, further comprising:
a light emitting control module and a light emitting module, wherein the driving module, the light emitting control module and the light emitting module are connected in series between a first power line and a second power line; and
a switching module, wherein a first terminal of the switching module is connected to the first terminal of the data writing module, a second terminal of the switching module is connected to the second terminal of the coupling module, and a control terminal of the switching module is connected to a scan line or a second control line;
wherein the light emitting control module comprises a fifth transistor and a sixth transistor;
the fifth transistor is connected between the first power line and a second terminal of the driving module; and the fifth transistor is configured to turn on in a reset stage and a light emitting stage;
the sixth transistor is connected between the first terminal of the driving module and a first terminal of the light emitting module; and the sixth transistor is configured to turn on in the light emitting stage;
a type of the fifth transistor is different from a type of the sixth transistor, a control electrode of the fifth transistor is connected to the second control line, and a control electrode of the sixth transistor is connected to a fourth control line; or, the type of the fifth transistor is the same as the type of the sixth transistor, a control electrode of the fifth transistor is connected to a third control line, and a control electrode of the sixth transistor is connected to a fifth control line; and
a second terminal of the light emitting module is connected to the second power line.

7. The pixel circuit according to claim 6, wherein a waveform of an active level of a third control signal on the third control line is the same as a waveform of an active level of a fifth control signal on the fifth control line; and the active level of the third control signal on the third control line, relative to the active level of the fifth control signal on the fifth control line, is delayed by one line time.

8. The pixel circuit according to claim 6, further comprising:
a threshold compensation module, wherein the threshold compensation module is connected between the control terminal of the driving module and the second terminal of the driving module; and the threshold compensation module is configured to turn on in a compensation stage to perform threshold compensation on the driving module;
wherein the threshold compensation module comprises a second transistor, and a type of the second transistor is different from the type of the fifth transistor;
the light emitting module comprises an organic light emitting diode, a first electrode of the organic light emitting diode is connected to the sixth transistor, and a second electrode of the organic light emitting diode is connected to the second power line; and
the reset stage is before the compensation stage.

9. The pixel circuit according to claim 2, further comprising:
a first reset module and a light emitting module, wherein a first terminal of the first reset module is connected to a first reset signal line, a second terminal of the first reset module is connected to a first terminal of the light emitting module; a control terminal of the first reset module is connected to a sixth control line or a seventh control line; and the first reset module is configured to turn on in a reset stage, the compensation stage and the data writing stage; and
a second reset module, wherein the second reset module is connected between the second terminal of the first reset module and the first terminal of the driving module, a control terminal of the second reset module is connected to an eighth control line; and the second reset module is configured to turn on in the reset stage and the compensation stage;
wherein the threshold compensation module is further configured to turn on in the reset stage.

10. The pixel circuit according to claim 2, further comprising:
a second reset module, wherein the second reset module is connected between a second reset signal line and the first terminal of the driving module, a control terminal of the second reset module is connected to an eighth control line; and the second reset module is configured to, in a reset stage and the compensation stage, transmit a second reset voltage on the second reset signal line to the first terminal of the driving module;
wherein the threshold compensation module is further configured to turn on in the reset stage;
the pixel circuit further comprising:
a first reset module and a light emitting module, wherein a first terminal of the first reset module is connected to a first reset signal line, a second terminal of the first reset module is connected to a first terminal of the light emitting module; a control terminal of the first reset module is connected to a sixth control line or a seventh control line; and the first reset module is configured to turn on in the reset stage, the compensation stage and a data writing stage.

11. The pixel circuit according to claim 9, further comprising:
a storage module, wherein the storage module is connected between the second terminal of the first reset module and the second terminal of the coupling module; and the storage module is configured to store the data voltage;
wherein the storage module comprises a second capacitor, and the second capacitor is connected between the second terminal of the first reset module and the second terminal of the coupling module.

12. The pixel circuit according to claim 10, wherein a second terminal of the light emitting module is connected to a second power line, and a first reset voltage is less than a sum of a second power voltage on the second power line and a turn-on voltage of the light emitting module;
a second terminal of the driving module is connected to a first power line, and the second reset voltage is less than a difference between a first power voltage on the first power line and a threshold voltage of a transistor in the driving module; and
the second reset voltage is greater than the first reset voltage.

13. The pixel circuit according to claim 9, further comprising a light emitting control module;
wherein the light emitting control module comprises a fifth transistor and a sixth transistor; the fifth transistor is connected between a first power line and a second terminal of the driving module; the sixth transistor is connected between the first terminal of the driving module and the first terminal of the light emitting module; and a control electrode of the sixth transistor is connected to a fourth control line or a fifth control line;
the fourth control line is reused as the sixth control line;
the fifth control line is reused as the seventh control line;
the pixel circuit further comprises a threshold compensation module; and a control terminal of the threshold compensation module is connected to a first control line, and the first control line is reused as the eighth control line.

14. The pixel circuit according to claim 13, wherein
a control electrode of the fifth transistor is connected to a third control line; a time period when a third control signal on the third control line is at an active level partially overlaps with a time period when the first control signal on the first control line is at an active level, and an overlapping duration is less than or equal to one line time; and the active level of the third control signal on the third control line, relative to an active level of a fifth control signal on the fifth control line, is delayed by one line time;
or, a control electrode of the fifth transistor is connected to a second control line, and an active level of a second control signal on the second control line, relative to an active level of the first control signal on the first control line, is delayed by one line time.

15. The pixel circuit according to claim 14, wherein a turn-on duration of the fifth transistor in the reset stage, controlled by the third control signal, is less than or equal to one line time;
or, a turn-on duration of the second reset module in the reset stage, controlled by the first control signal, is less than or equal to one line time.

16. The pixel circuit according to claim 14, wherein the first reset module comprises a seventh transistor, and a type of the seventh transistor is different from a type of the sixth transistor.

17. The pixel circuit according to claim 13, wherein
a control terminal of the data writing module is connected to a scan line;
when a refresh frequency of a display panel corresponding to the pixel circuit is less than a preset frequency, a frequency of an active level of a fourth control signal on the fourth control line is greater than a frequency of an active level of a scan signal on the scan line;
a frequency of an active level of a fifth control signal on the fifth control line is greater than a frequency of an active level of a scan signal on the scan line;
a frequency of an active level of a scan signal on the scan line is the same as a frequency of an active level of the first control signal on the first control line; and
when a refresh frequency of the display panel is greater than or equal to a preset frequency, a frequency of an active level of a fourth control signal on the fourth control line, a frequency of an active level of a scan signal on the scan line and a frequency of an active level of the first control signal on the first control line are the same.

18. The pixel circuit according to claim 17, wherein when a refresh frequency of the display panel is less than a preset frequency, one display frame of a display panel corresponding to the pixel circuit comprises a writing frame and a holding frame; the reset stage comprises a first reset sub-stage located in the writing frame and a second reset sub-stage located in the holding frame; and the first reset module is configured to, in the first reset sub-stage and the second reset sub-stage, turn on in response to the fourth control signal or the fifth control signal to transmit a first reset voltage on the first reset signal line to a first terminal of the light emitting module.

19. The pixel circuit according to claim 9, wherein the first reset module comprises a seventh transistor, a first electrode of the seventh transistor is connected to the first reset signal line, a second electrode of the seventh transistor is connected to a first terminal of the light emitting module, and a control electrode of the seventh transistor is connected to the sixth control line or the seventh control line;
the second reset module comprises an eighth transistor, the eighth transistor is connected between a first terminal of the light emitting module and a second terminal of the driving module, and a control electrode of the eighth transistor is connected to an eighth control line; and
the eighth transistor is an N-type transistor.

20. The pixel circuit according to claim 10, wherein
the first reset module comprises a seventh transistor, a first electrode of the seventh transistor is connected to the first reset signal line, a second electrode of the seventh transistor is connected to a first terminal of the light emitting module, and a control electrode of the seventh transistor is connected to the sixth control line or the seventh control line;
the second reset module comprises an eighth transistor, the eighth transistor is connected between the second reset signal line and a first terminal of the driving module, and a control electrode of the eighth transistor is connected to an eighth control line; and
the eighth transistor is an N-type transistor.

21. A driving method for a pixel circuit, wherein the pixel circuit comprises a driving module, a coupling module and a data writing module, a first terminal of the coupling module is connected to a control terminal of the driving module; a first terminal of the data writing module is connected to a first terminal of the driving module, and the first terminal of the data writing module is further connected to a second terminal of the coupling module;
the driving method comprising:
in a data writing stage, turning on the data writing module to transmit a data voltage to the second terminal of the coupling module, and using the coupling module to couple a voltage containing data voltage information at the second terminal of the coupling module to the control terminal of the driving module.
